(19) United States
(12) Patent Application Publication
(10) Pub. No.: US 2025/0317400 A1
(43) Pub. Date: Oct. 9, 2025

(54) Methods and Apparatus for Using Stream Classification Service to Enable Low Latency Treatment of MAC Service Data Units (MSDUs) in Wireless Local Area Networks (WLANs)

(71) Applicant: Charter Communications Operating, LLC, St. Louis, MO (US)

(72) Inventors: Maulik Vaidya, Escondido, CA (US); Nima Namvar, Charlotte, NC (US)

(21) Appl. No.: 18/631,040

(22) Filed: Apr. 9, 2024

(51) Int. Cl. H04L 47/2441; H04W 28/02; H04W 84/12

(52) U.S. Cl. CPC H04L 47/2441; H04W 28/0252; H04W 84/12

(57) ABSTRACT

A new mode of operation, which is a WiFi L4S mode of operation, sometimes referred to as a dot11L4SActivated-true mode, is implemented and used to identify and prioritize low latency traffic without the need for extensive hardware modifications. With SCS framework, a new frame classifier type, e.g., classifier type=11, is implemented, which indicates that the type of classifier parameters are additional qualifiers which may help to determine QoS information, e.g., determine how many frames per second (fps) for a video flow is required.

### FIELD

The present invention is directed to wireless communications, and more particularly, to methods and apparatus for supporting L4S in WLANs.

### BACKGROUND

An overview of Stream Classification Service (SCS) for Wi-Fi Quality of Service (QOS) Management will now be described. SCS is a crucial component of Wi-Fi QoS Management, a technology for prioritizing specific network traffic types. SCS performs Traffic Identification and Classification. SCS analyzes network data flow and categorizes it based on characteristics such as: i) application type (e.g., video call, gaming), ii) source and destination IP addresses, and iii) other relevant factors. SCS facilitates enabling QoS treatment. After classification, SCS allows the access point (AP) to apply different Quality of Service (QOS) levels to various traffic types. This prioritizes traffic like real-time calls, minimizing delays and buffering. QoS treatment includes: selecting alternative Enhanced Distributed Channel Access (EDCA) queues (congestion control mechanisms) and defining drop eligibility (determining which packets can be discarded during congestion).

SCS operations will now be described. The client device, sometimes referred to as a station (STA) uses SCS to inform the AP about its traffic types, e.g., video call, gaming, etc. The client also specifies desired QoS characteristics for each traffic type, like delay tolerance and jitter (unwanted fluctuations in delay). The AP utilizes this information to prioritize the identified traffic in the downlink (data flow from the AP to the client). SCS helps the AP understand and prioritize different traffic types. SCS enables efficient network resource allocation and improves user experience for critical applications.

An overview of Mirrored-SCS (MSCS) will now be described. MSCS leverages uplink traffic observation. Unlike SCS, which relies on the client explicitly providing classification parameters and desired QoS settings, MSCS focuses on observing the uplink traffic initiated by the client. MSCS Identifies multiple related streams. Based on observed parameters like source IP address and port number, the AP identifies multiple traffic streams sharing the same characteristics, not just a single stream like in SCS. MSCS derives QoS from reverse stream (local area network (LAN) only). Instead of the client specifying desired QOS (as is the case in SCS, in MSCS the AP mirrors the QoS (User Priority) from the corresponding reverse traffic stream flowing from the client to the AP. This approach is suitable only for LAN environments due to its reliance on local traffic observation.

With regard to MSCS there is flexibility in classification parameters. Similar to SCS, MSCS allows the client to specify the type of classification parameters (e.g., source IP, port), but not their specific values. MSCS key differences from SCS will now be described. MSCS focuses on uplink traffic observation, not explicit client information. MSCS identifies and manages multiple related streams. MSCS derives QoS from reverse stream (limited to LAN).

FIG. 1 is a table 100 illustrating a comparison between SCS and MSCS. First column 102 illustrates features which are being compared. Second column 104 includes information about each feature with regard to SCS. Third column 106 includes information about each feature with regard to MSCS.

First row 108 provides a comparison for the feature=client initiation. In SCS, the STA explicitly requests QoS treatment. In MSCS the STA implicitly provided information through traffic.

Second row 110 provides a comparison for the feature=information provided. In SCS, the information provided includes traffic type and desired QoS characteristics. In MSCS the information provided includes traffic type extracted from network observation.

Third row 112 provides a comparison for the feature=complexity for client. SCS requires configuration and knowledge of QoS. MSCS is simple for clients with no specific configuration needed.

Fourth row 114 provides a comparison for the feature=flexibility for client. SCS offers customization of the desired QoS parameters. MSCS has limited flexibility and relies on network interpretation.

Fifth row 116 provides a comparison for the feature=complexity for AP. SCS requires parsing of the client request and QoS mapping. MSCS requires traffic analyses and mapping based on pre-defined rules.

Sixth row 118 provides a comparison for the feature=support for L4S. SCS does not currently include support for L4S. MSCS does not currently include support for L4S.

An overview of L4S will now be described. L4S stands for Low Latency, Low Loss, and Scalable Throughput. It is a relatively new technology which was introduced in RFC 9330 to address the queueing delay for the IP traffic.

L4S operation will now be described. With L4S, a Dual Queue Implementation is used. Network traffic is separated into two queues, one for L4S traffic and another for traditional TCP traffic. With L4S, Explicit Congestion Control Notification (ECN) Signaling is used. The ECN bits in the IP header are used by the sender to mark its packet as “L4S capable”. Network sends early congestion signal by marking IP packet with a Congestion-experienced code (CE) Receiver sends congestion feedback to the sender. Sender adjusts its transmission rate dynamically based on the received congestion signals.

FIG. 2 is a drawing of an exemplary IP header 200 including and ECN portion 240 (used for L4S) and a legend 250 illustrating the mapping of ECN bit values. IP header 200 includes 16 bits (Bit 0 202, Bit 1 204, Bit 2 206, Bit 3, 208, Bit 4 210, Bit 5 212, Bit 6 214, Bit 7 216, Bit 8 218, Bit 9 220 Bit 10 222, Bit 11 224, Bit 12 226, Bit 13 228, Bit 14 230, Bit 15 232). First IP header portion 234, which includes Bit 0 202, Bit 1 204, Bit 2 206 and Bit 3 208, is used to convey the IP version, e.g. IP version=4. Second IP header portion 236, which includes Bit 4 210, Bit 5 212, Bit 6 214 and Bit 7 216, is used to convey the Header Length (Len). Third IP header portion 238, which includes Bit 8 218, Bit 9 220, Bit 10 222, Bit 11 224, Bit 12 226, and Bit 13 228, is used to convey Differential Service Code Point (DSCP). Fourth IP header portion 240 which includes Bit 14 230, which is the ECT bit, and Bit 15 232, which is the CE bit, is used to convey the Explicit Congestion control Notification (ECN) bits.

Legend 250 indicates: ECN bit pattern=00 means not ECN capable; ECN bit pattern=10 means classic ECN-capable transport; ECN bit pattern=01 means L4S-capable transport; and ECN bit pattern=11, which is the congestion experienced codepoint, means congestion experienced.

With the proliferation of wireless local area networks (WLANs), e.g. WiFi WLANS, the use of a variety of different types of applications with widely different levels of QOS requirements using the same access point, and the proliferation of the use of applications, e.g., gaming applications, real time applications, virtual reality (VR)/augmented reality (AR)/extended reality (ER) applications, etc., which benefit from and/or need low loss, low latency and high throughput communications, there is a need for new methods and apparatus to support efficient L4S in WiFi networks. It would be advantageous if at least some of new methods and/or apparatus could leverage existing SCS and/or MSCS, or portions of such services, or revise them or use them in combination with other signaling or features in a manner that supports L4S and/or L4S like communications and/or functionality, e.g., in access points and/or stations.

### SUMMARY

A new mode of operation, which is a WiFi L4S mode of operation, sometimes referred to as a dot11L4SActivated=true mode, is implemented and used to identify and prioritize low latency traffic without the need for extensive hardware modifications. With SCS framework, a new frame classifier type, e.g., classifier type=11, is implemented, which indicates that the type of classifier parameters are additional qualifiers which may help to determine QoS information, e.g., determine how many frames per second (fps) for a video flow is required. An exemplary new classifier parameter is ECN{11}. A SCS request frame including a SCS descriptor element including a transmission classification (TCLAS) element including a frame classifier conveying the new frame classifier type (value=11) and the new frame classifier parameter ECN{11} is generated and sent to an access point. Upon the access point accepting the request, the AP implements congestion evaluations and ECN congestion detected codepoint marking operations at its transmission queues, e.g., its video and/or voice transmission queues. The access point interprets an ECN=11 in an IP header, for data to be transmitted by the AP, as a request for L4S like treatment and adjusts, e.g., sets, the video transmission rate for the frame at a value satisfying an L4S data transmission rate criteria.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a table comparing prior art SCS to MSCS

FIG. 2 is drawing illustrating an exemplary IP header including an ECN field.

FIG. 3 is drawing of an exemplary communications system in accordance with an exemplary embodiment.

FIG. 4 is a signaling diagram illustrating an exemplary setup and termination protocol exchange for L4S over SCS in accordance with an exemplary embodiment.

FIG. 5 is a table illustrating exemplary MLME primitives (for SCS), used to support L4S, in accordance with an exemplary embodiment.

FIG. 6 is drawing illustrating an exemplary SCS request frame format, in accordance with an exemplary embodiment, said SCS request frame including a novel L4S descriptor element, included as part of a SCS descriptor element, included as part of a SCS descriptor list in the SCS frame.

FIG. 7 is a flowchart of an exemplary method of operating an access point in accordance with an exemplary embodiment, said exemplary method including using a L4S classifier filter to filter received MSDUs, said L4S classifier filter having been setup via SCS framework.

FIG. 8 is a signaling diagram illustrating an exemplary setup and termination protocol exchange for L4S over MSCS in accordance with an exemplary embodiment.

FIG. 9 is a table illustrating exemplary MLME primitives (for MSCS), used to support L4S, in accordance with an exemplary embodiment.

FIG. 10 is drawing illustrating an exemplary MSCS request frame format, in accordance with an exemplary embodiment, said MSCS request frame including a novel L4S descriptor element, included as part of a MSCS descriptor element, included as part of a MSCS descriptor list in the MSCS frame.

FIG. 11 is a flowchart of an exemplary method of operating an access point in accordance with an exemplary embodiment, said, said exemplary method including using a L4S classifier filter to filter received MSDUs, said L4S classifier filter having been setup via MSCS framework.

FIG. 12 is a drawing of an exemplary access point (AP) in accordance with an exemplary embodiment, said exemplary AP supporting a version of SCS which includes support for L4S and/or supporting a version of MSCS which includes support for L4S.

FIG. 13 is a drawing of an exemplary client device station (STA) in accordance with an exemplary embodiment, said exemplary STA supporting a version of SCS which includes support for L4S and/or supporting a version of MSCS which includes support for L4S.

FIG. 14 is a drawing of an exemplary IP header including an ECN portion and a legend illustrating the mapping of ECN bit values for dot11L4SActivated=true mode, in accordance with an exemplary embodiment.

FIG. 15 is a drawing illustrating an exemplary SCS descriptor element format in accordance with an exemplary embodiment.

FIG. 16 is a drawing 1600 illustrating an exemplary TCLAS element format in accordance with an exemplary embodiment.

FIG. 17 is a drawing 1700 illustrating an exemplary frame classifier field format in accordance with an exemplary embodiment.

FIG. 18 is a drawing of an exemplary frame classifier type table, in accordance with an exemplary embodiment, said exemplary frame classifier type table includes a novel classifier type 11 (which was previously reserved) which has been designated to correspond to a type of classifier parameters, which are additional qualifiers which may be, and sometimes are used, to determine QoS, e.g. how many frames per second (fps) for video is required.

FIG. 19 is a drawing of an exemplary SCS request frame in accordance with an exemplary embodiment which includes: i) a classifier type field value=11, which signifies that the classifier parameter(s) are additional qualifiers which may help to determine QoS information, e.g. how many frames per second (fps) for video flow is required, and a classifiers parameters field which includes the parameter ECN{11}.

FIG. 20A is a first part of flowchart of an exemplary communications method in accordance with an exemplary embodiment.

FIG. 20B is a second part of flowchart of an exemplary communications method in accordance with an exemplary embodiment.

FIG. 20 comprises the combination of FIG. 20A and FIG. 20B.

FIG. 21 is drawing illustrating exemplary components including transmission queues included in an exemplary AP and exemplary operations which are performed in accordance with an exemplary embodiment, e.g., prior to receiving a SCS w/L4S Request Frame or a MSCS w/L4S Request Frame.

FIG. 22 is drawing 2200 illustrating exemplary components including transmission queues included in an exemplary AP and exemplary operations which are performed in accordance with an exemplary embodiment, e.g., subsequent to accepting a SCS w/L4S Request Frame or a MSCS w/L4S Request Frame, selecting a L4S queue, and creating a L4S filter.

FIG. 23 is drawing illustrating exemplary components including transmission queues included in an exemplary AP and exemplary operations which are performed in accordance with an exemplary embodiment.

### DETAILED DESCRIPTION

In some embodiments, in accordance with the present invention, a client-driven network optimization approach is implemented to enable L4S in WLANs. This client driven network optimization approach enables fine-tuned traffic classification, QoS, and/or congestion control. In some such embodiments, a new L4S filter within the Stream Classification Service (SCS) framework is introduced, implemented and used.

Aspects of filter functionality of the new L4S filter relate to: L4S traffic identification, congestion detection, and QoS treatment. The new L4S filter identifies IP packets belonging to L4S flows based on specific criteria or vendor-defined mechanisms. The new L4S filter additionally identifies congestion-experienced L4S packets using techniques such as Explicit Congestion Notification (ECN) or other congestion indicators.

Once L4S traffic is identified by using the new L4S filter, the new L4S filter enables appropriate QoS treatment for L4S traffic with regard to: Setting User Priority, Alternate EDCA Queue, and Drop Eligibility. Setting User Priority (UP): assigns a higher priority level to ensure timely delivery. Alternate EDCA Queue: selects an appropriate Enhanced Distributed Channel Access (EDCA) queue for efficient L4S traffic handling. Drop Eligibility: defines the conditions under which L4S packets can be dropped during congestion, balancing network performance and service prioritization.

With regard to filter operation, there is an L4S support requirement that both the AP and STA must support L4S service for this filter to function.

With regard to client-driven filter setup, the client device triggers a local filter creation at the AP to classify downstream L4S traffic. The client provides the following information during setup:
ECN Threshold: Defines the congestion level at which the client starts sending ECN signals.
Latency Target: Specifies the desired maximum delay for L4S traffic.
Loss Tolerance: Defines the acceptable packet loss rate for the L4S flow.
Desired Bandwidth: Indicates the preferred minimum bandwidth allocation for L4S traffic.

With regard to traffic prioritization, L4S traffic classified by the filter receives low-latency scheduling, ensuring preferential treatment in terms of resource allocation and transmission opportunities.

Some key points will now be presented. This solution integrates L4S-specific functionalities within the existing SCS framework for efficient L4S traffic management.

Client-provided information guides the filter configuration, enabling tailored QoS treatment for L4S applications. The filter prioritizes L4S traffic while considering congestion and network resource constraints.

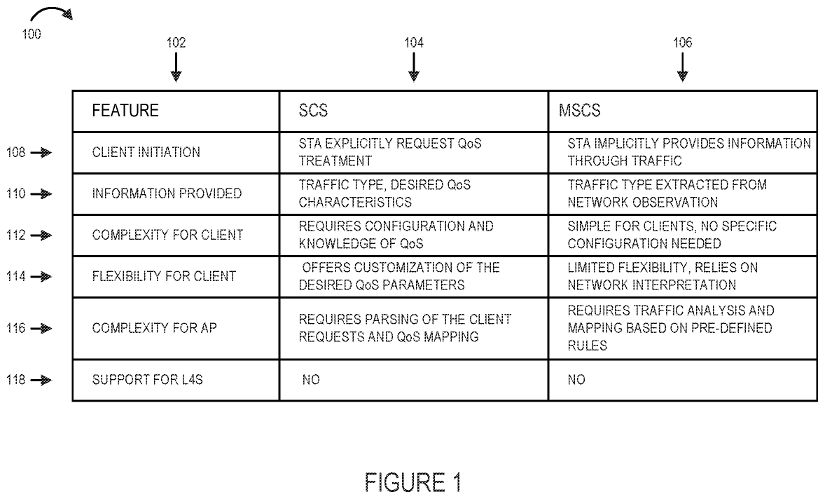

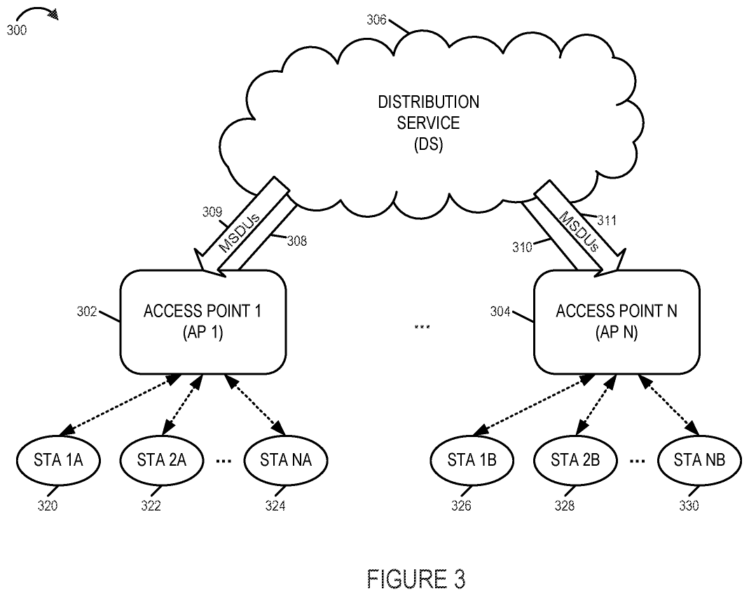

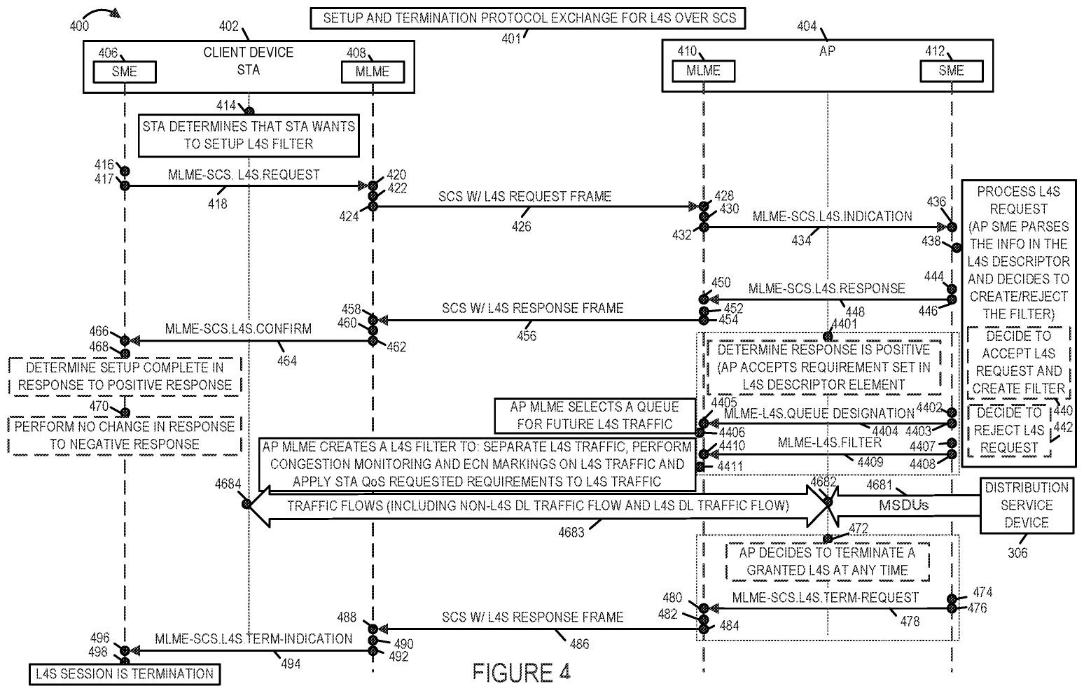

FIG. 4 is a signaling diagram 400, which illustrates an exemplary setup and termination protocol exchange for L4S over SCS framework, as indicated by title information block 401, in accordance with an exemplary embodiment. FIG. 4 includes exemplary client device station (STA) 402 and exemplary access point (AP) 404. Exemplary client device STA 402 is, e.g., any of the STAs of system 300 of FIG. 3, and AP 404 is, e.g. any of the APs of system 300 of FIG. 3. For example, STA 402 is, e.g. STA 1A 320 of system 300 of FIG. 1 and AP 404 is AP 1 302 of system 300 of FIG. 1. STA 402 and AP 404 support a version of SCS which supports L4S, in accordance with features of the present invention. STA 402 includes station management entity (SME) 406 and MAC sublayer management entity (MLME) 408. AP 404 includes MLME 410 and SME 412.

In step 414 STA 402 decides that it wants to setup an L4S filter. In response to the decision to setup the L4S filter, in step 416 the SME 406 of STA 402 generates MLME-SCS.L4S.Request 418. In step 417 the SME 406 of STA 402 sends the generated MLME-SCS.Request 418 to MLME 408 of STA 402. In step 420, MLME 408 of STA 402 recevies the MLME-SCS. Request 418 and recovers the communicated information. In step 422, MLME 408 of STA 402, in response to the received MLME-SCS.Request 418, generates SCS w/L4S Request frame 426 in step 422 and sends, in step 424 the SCS w/L4S Request frame 426 to AP 404. Thus, in step 424, STA 402 sends, e.g., transmits SCS w/L4S request frame 426 to AP 404.

In step 428, AP 404, including MLME 410, receives the SCS w/L4S Request frame 426. In response to MLME 410 of AP 404 receiving the SCS w/l4S request frame, MLME 410 generates and sends MLME-SCS.L4S. Indication 434 to SME 414 of AP 404. In step 436 the SME 412 of AP 404 receives the MLME-SCS.L4S. Indication 434. In response to the received MLME-SCS.L4S. Indication 434, in step 438 SME 412 of AP 404 processes the L4S request communicated in the MLME-SCS.L4S. Indication 434, e.g., the AP SME 412 parses the information in the L4S descriptor and decides to create or reject the filter. Step 438 includes steps 440 and 442, and one of steps 440 and 442 is performed for each iteration of step 438. In step 440 the AP SME 412 decides to accept the L4S request and create an L4S filter, in accordance with the request. In step 442 the AP SME 412 decides to reject the L4S request

Operation proceeds from step 440, when performed to step 4401, in which the AP 4401 determines that the response is positive, e.g., the AP 404 accepts the requirement set in the L4S descriptor element, and operation proceeds to step 4402 and step 4407. In step 4402 SME 414 generates MLME-L4S.QueueDesignation 4404, and in step 4403 SME 412 sends MLME-L4S.QueueDesignation 4404 to the MLME 410 of the AP 404, which the MLME 410 receives in step 4405. In step 4406, the MLME 410, in response to the received MLME-L4S.QueueDesignation 4404, selects (e.g., designates) a queue for future L4S traffic. Thus, in step 410 the AP 404 selects and assigns one of its queues to be a L4S queue (for downlink L4S traffic). Thus, the AP 404 will have a queue for DL L4S traffic and a queue for DL non-L4S (regular) traffic.

In step 4407 SME 414 generates MLME-L4S.Filter 4409, and in step 4408 SME 412 sends MLME-L4S.Filter 4409 to the MLME 410 of the AP 404, which the MLME 410 receives in step 4410. In step 4411, the MLME 410, in response to the received MLME-L4S.Filter 4404, creates a filter, referred to as an L4S filter, to separate L4S traffic from regular (non-L4S traffic), e.g., based on information included in the received L4S classifier mask (e.g., source IP addresses and corresponding port #s which corresponding to L4S data streams), to perform congestion monitoring and ECN marking in L4S traffic in the L4S buffer (e.g., using the ECN threshold including in the L4S descriptor element), and to apply STA requested QoS requirements (e.g. latency target, desired bandwidth (BW) and loss tolerance) with regard to L4S traffic being transmitted by the AP. The L4S filter created in step 4411, in accordance with the AP accepted L4S descriptor element requirements communicated in the received L4S request frame, will be used to process received MSDUs from a distribution service to identify which MSDUs are conveying L4S data.

In step 444, the SME 412 of AP 404 generates MLME-SCS.L4S response 448, which includes the decision of step 438, e.g., accept or reject, and in step 446 sends MLME-SCS.L4S response 448 to MLME 410 of the AP 404. In step 450 the MLME 410 of AP 404 receives the MLME-SCS.L4S.response 448, and in response to the received MLME-SCS.L4S response 448, in step 452 MLME 410 of AP 404 generates a SCS w/L4S Response frame 456, which includes the accept/reject decision. In step 454 the AP 404 sends the SCS w/L4S Response frame 456 to the MLME 408 of the STA 402. In this way AP 404 communicates the SCS w/L4S Response frame 456 to STA 402.

In step 458 the MLME 408 of STA 402 receives the SCS w/L4S Response frame 456, and in response, in step 460 the MLME generates a MLME-SCS.L4S.confirm 464, which includes an indication of accept or reject, and in step 462 sends the MLME-SCS.L4S.confirm 464 to the SME 406. In step 466, the SME 406 receives the MLME-SCS.L4S and recovers the communicated information, e.g., identifying whether the response was positive or negative. If the received response is positive, then operation proceeds from step 466 to step 468, in which the SME 406 of STA 402 determines that the setup is complete, e.g., STA 402 determines that AP 404 has implemented the requested L4S filter. However, if the received response is negative, then operation proceeds from step 466 to step 470, in which the SME 406 of STA 402 performs no change in response to the negative response, e.g., STA 402 recognizes that AP 404 has rejected its L4S filter request, and STA 402 recognizes that AP 404 will not be separating its downlink traffic into L4S traffic and non-L4S (regular) traffic.

Consider that AP 404 has decided to accept the L4S request, e.g., step 440 was executed, AP 404 designated a queue for L4S traffic in step 4406 and the AP 404 created a L4S filter, in accordance with STA generated L4S descriptor element, communicated in SCS w/L4S request frame 426. AP 404 receives MSDUs 4681 from distribution service device 306, and performs operations 4682, which includes performing filtering in accordance with the generated L4S filter, which results in traffic flows 4683 including a non-L4S DL traffic flow and a L4S DL traffic flow. Operation 4682 includes, e.g., steps in flowchart 700 starting at step 703 and proceeding forward through the flow toward steps 724/725. Multiple iterations of the flow starting at step 703 are performed, e.g., as multiple received MDUs are received and processed.

In step 472 AP 404 decides to terminate the granted L4S. In response to the L4S termination determination, in step 474 SME 412 of AP 404 generates MLME-SCS.L4S. TERM-request 478 and in step 476 sends the generated MLME-SCS.L4S. TERM-request 478 to the MLME 410 of AP 404. In step 480, MLME 410 receives the MLME-SCS.L4S. TERM-request 478, and in response to the reception, in step 482 MLME 410 of AP 404 generates a SCS w/L4S response frame 486. In step 484 AP 404 sends the generated SCS w/L4S response frame 486 to the MLME of STA 402. In step 488 the MLME 408 of STA 402 receives the SCS w/L4S Response frame 488, which is an unsolicited SCS w/L4S response frame. In step 490 the MLME 408, in response to receiving an unsolicited SCS w/L4S response frame, generates a MLME-SCS.L4S TERM-Indication, and in step 492 MLME 492 sends the MLME-SCS.L4S TERM-Indication 494 to the SME 406 of STA 402. In step 496 the SME 406 of STA 402 receives the MLME-SCS.L4S TERM-Indication 494, and, in response, in step 494 the L4S session is terminated.

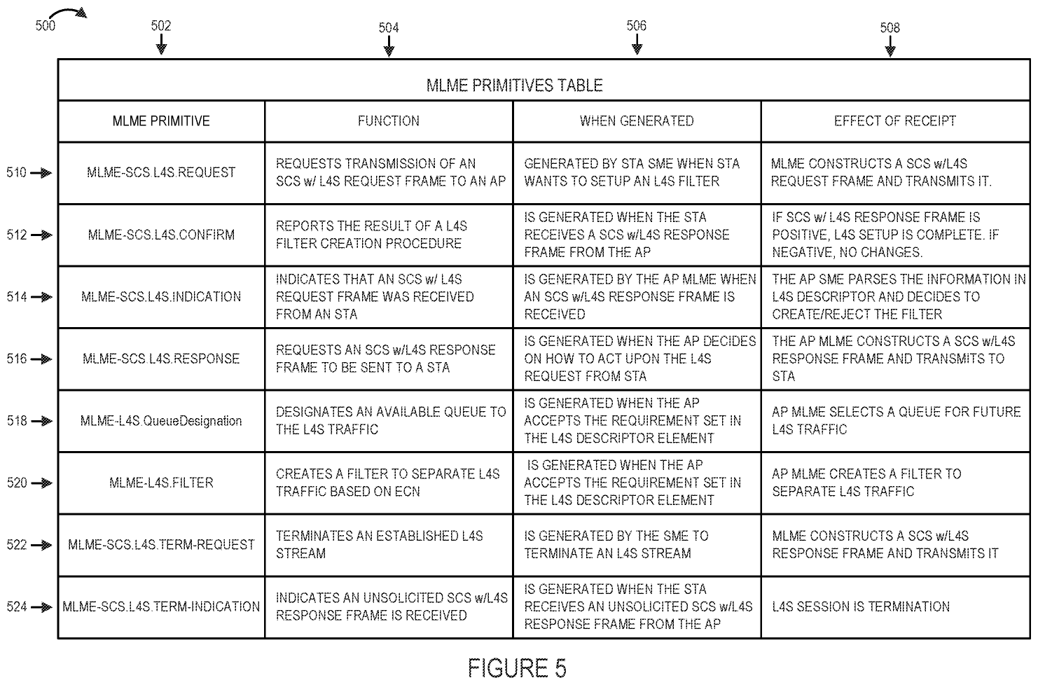

FIG. 5 is a table 500 illustrating exemplary novel MLME primitives (for SCS), used to support L4S, in accordance with an exemplary embodiment. Table 500 provides information regarding the primitives included in the exemplary signaling diagram 400 of FIG. 4. First column 502 lists the primitives. Second column 504 describes the function for each primitive. Third column 506 includes information indicating when the primitive is generated. Fourth column 508 indicates the effect of receipt of the primitive. First row 510 includes information corresponding to the MLME primitive designated as MLME-SCS.L4S.Reqeust. Second row 512 includes information corresponding to the MLME primitive designated as MLME-SCS.L4S.Confirm. Third row 514 includes information corresponding to the MLME primitive designated as MLME-SCS-L4S. Indication. Fourth row 516 includes information corresponding to the MLME primitive designated as MLME-SCS.L4S.Response. Fifth row 518 includes information corresponding to the MLME primitive designated as MLME-L4S.QueueDesignation. Sixth row 520 includes information corresponding to the MLME primitive designated as MLME-L4S.Filter. Seventh row 522 includes information corresponding to the MLME primitive designated as MLME-SCS.L4S.TERM-request. Eighth row 524 includes information corresponding to the MLME primitive designated as MLME-SCS.L4S.TERM-Indication.

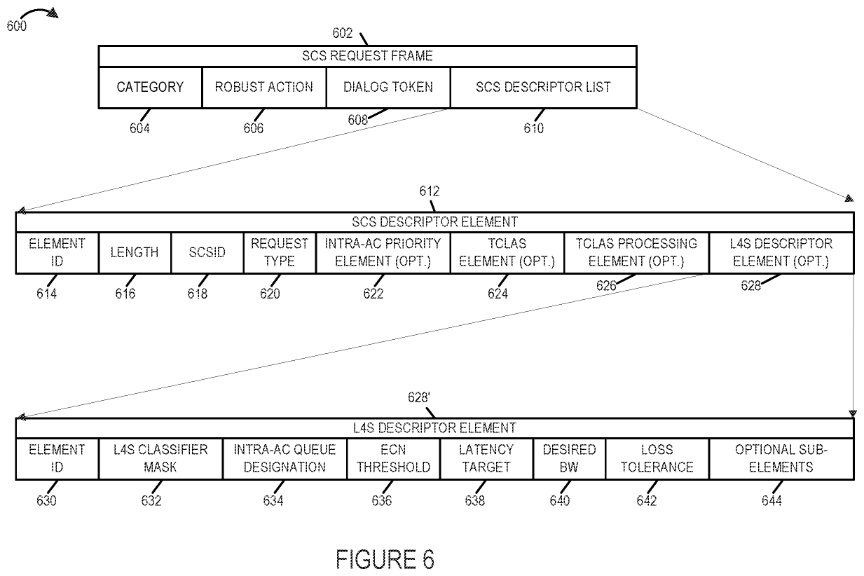

FIG. 6 is drawing 600 illustrating an exemplary SCS request frame format used for a SCS request frame 602, in accordance with an exemplary embodiment, said SCS request frame 602 including a novel L4S descriptor element 628′, included as part of a SCS descriptor element 612, included as part of a SCS descriptor list 610 in the SCS request frame 602.

Exemplary SCS request frame 602 includes a category portion 604, a robust action portion 606, a dialog token portion 608 and a SCS descriptor list portion 610. The SCS descriptor list portion 610 includes one or more SCS descriptor elements 612. An SCS descriptor element 612 includes an element ID portion 614, a length portion 616, a SCSID portion 618, a request type portion 620, a intro-AC priority element (optional) portion 622, a TCLAS element (optional) portion 624, a TCLAS processing element (optional) portion 626, and a L4S descriptor element (optional) portion 628. L4S descriptor element 628′ is, e.g., L4S descriptor element 628. L4S descriptor element 628′ includes an element ID portion 630, a L4S classifier mask portion 632, an Intra-AC queue designation portion 634, a ECN threshold portion 636, a latency target portion 638, a desired bandwidth (BW) portion 640, a loss tolerance portion 642, and an optional sub-elements portion 644.

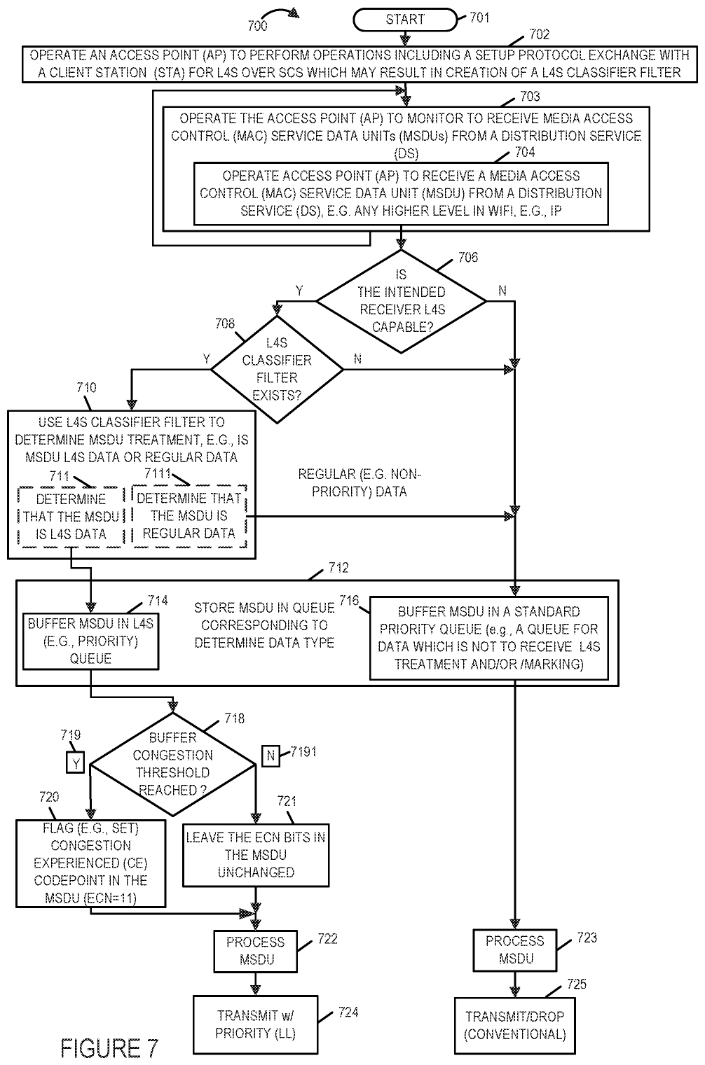

FIG. 7 is a flowchart of an exemplary method of operating an access point (AP) in accordance with an exemplary embodiment. The AP implementing the method of flowchart 700 is, e.g., any of AP 1 302 of FIG. 3, AP N of FIG. 3, or AP 404 of FIG. 4. Operation of the exemplary method starts in step 701, in which the AP is powered on and initialized. Operation proceeds from start step 701 to step 702. In step 702 the access point, e.g., AP 404, is operated to perform operations including a setup protocol exchange with a client station (STA), e.g., client STA 402, for L4S over SCS, which may result in creation of a L4S classifier filter, e.g., AP 404 performs steps 428, 430, 432, 436, 438, 440, 4401, 4402, 4403, 4405, 4406, 4407, 4408, 4410, 4411, 444, 446, 450, 452 and 454, of signaling diagram 400 resulting in L4S filter establishment in step 4411. Operation proceeds from step 702 to step 703.

In step 703, the AP monitors to receive media access control (MAC) service data units (MSDUs) from a distribution service, e.g., distribution service device 306. Step 703 is performed repetively, on an ongoing basis. Step 703 includes step 704, in which the AP receives a MSDU from a distribution service, e.g., at any higher level in WiFi, e.g. at the IP level. In response to the reception of a MSDU in step 704, operation proceeds from step 704 to step 706.

In step 706, the AP determines if the intended receiver, e.g., the intended STA corresponding to the received MSDU, is L4S capable. If the determination is that the intended receiver is L4S capable then operation proceeds from step 706 to step 708; otherwise, operation proceeds from step 706 to step 716.

In step 708 the AP determines whether or not a L4S classifier filter exists, e.g., the AP determines whether or not it has a created L4S classifier filter, corresponding to the STA, which is the intended recipient of the received MSDU. If the determination of step 708 is that the AP does not have a L4S classifier filter then, operation proceeds from step 708 to step 716. However, if the determination is that the AP has a L4S classifier filter, then operation proceeds from step 708 to step 710.

In step 710 the AP uses the L4S classifier filter to determine MSDU treatment, e.g., is the MSDU conveying L4S data or regular data. Step 710 includes step 711 and step 7111, one of which is executed for each iteration of step 710.

In step 711 the AP determines that the MSDU is L4S data, and operation proceeds from step 711 to step 714 of step 712. Alternatively, in step 7111, the AP determines that the MSDU is regular data, and operation proceeds from step 7111 to step 716 of step 712.

In step 712 the AP stores the MSDU in a queue corresponding to the determined data type. In step 714, the AP stores, e.g. buffers, the MDSU in a L4S (e.g., priority) queue, and operation proceeds from step 714 to step 718. Alternatively, in step 716, the AP stores, e.g., buffers, the MSDU in a standard priority queue (e.g., a queue for data which is not to receive L4S treatment and/or marking), and operation proceeds from step 716 to step 723.

Returning to step 718, in step 718 the AP determines if a buffer congestion threshold for the L4S queue (buffer) has been reached. If the determination is that the buffer congestion threshold has been reached, as indicated by Y 719, then operation proceeds from step 718 to step 720, in which the AP flags, e.g. sets, a congestion experienced (CE) codepoint in the MSDU, e.g., the AP sets the ECN bits (ECT, CE)=pattern (11), in the ECN field of the header of the MSDU indicating congestion experienced. Alternatively, if the determination is that the buffer congestion threshold has not been reached, as indicated by N 7191, then operation proceeds from step 718 to step 721, in which the AP leaves the ECN bits in the MSDU unchanged.

Operation proceeds from step 720 or step 721 to step 722, in which the AP processes the MSDU. Operation proceeds from step 722 to step 724, in which the AP transmits the MSDU with priority (LL).

Returning to step 723, in step 723 the AP processes the MSDU. Operation proceeds from step 723 to step 725, in which the AP transmits or drops the MSDU, using the conventional approach.

In some embodiments, in accordance with the present invention, a network-driven QoS optimization approach is implemented for enabling L4S in WLANs. The network-driven QoS optimization approach enables fine-tuned traffic classification, QoS, and/or congestion control.

There is a motivation for a network driven QoS optimization approach, when one considers the strengths and challenges in the client-driven optimization approach, previously presented with regard to FIGS. 4-7. Strengths of the Flexible Client-Driven Classification approach include: i) support for both LAN (local area network) and WAN (wide area network) scenarios; and ii) flexibility in: stream classification, which enables defining classification parameters and desired QoS metrics. Challenges of the client driven QoS optimization approach includes difficulty for STAs (Stations) to identify L4S stream parameters in certain cases. Applications might only know the server's Fully Qualified Domain Name (FQDN), not its dynamic IP address. Limited STA framework APIs might hinder information gathering across network layers.

In some embodiments, in accordance with the present invention, a network-driven QoS optimization approach is implemented, in which AP-Driven Classification using Mirrored-SCS (MSCS) is implemented and used. One objective of implementing and using a AP-Driven Classification using Mirrored-SCS approach is to enable AP-driven L4S filter creation for multiple streams without requiring specific client information. This approach leverages the Mirrored-SCS (MSCS) framework to identify uplink traffic streams and focuses on stream monitoring, not mirrored QoS derivation due to L4S latency requirements. This AP-Driven Classification using Mirrored-SCS (MSCS) approach is well suited for LAN environments due to its reliance on local traffic observation.

Both solutions (the client driven network optimization approach using SCS and the AP-driven network optimization approach using MSCS) aim to manage L4S traffic effectively. The client driven network optimization approach using SCS prioritizes flexibility but requires more complex software on the client device. The AP-driven network optimization approach emphasizes AP-driven management but is limited in its flexibility to customize fine-tuned QoS treatment.

An overview of an exemplary AP-Driven Classification approach using Mirrored-SCS (MSC) for enabling L4S in WLANs will now be presented. An objective of this approach is to create a new capability on the AP to dynamically manage L4S traffic based on various parameter types (not their actual values). This approach leverages Mirrored Stream Classification Service (MSCS) framework for stream identification. A STA transmits MSCS w/L4S request specifying classification parameter types (e.g., source IP, port) but not specific values. The AP identifies multiple uplink traffic streams sharing the same parameter values. This approach, in accordance with the present invention, is differentiated from conventional MSCS in that the approach, used in various embodiments in accordance with the present invention, ignores “Mirrored” QOS derivation due to L4S traffic's low-latency nature. Thus, QoS in the approach, used in various embodiments in accordance with the present invention, is not derived from the reverse stream. This approach, in accordance with the present invention, is further differentiated from conventional MSCS in that this new approach, used in various embodiments in accordance with the present invention utilize MSCS only for stream monitoring, but not fir QoS assignment.

In the exemplary AP-Driven Classification approach using Mirrored-SCS (MSC) for enabling L4S in WLANs, in accordance with various embodiments of the present invention, with regard to dynamic L4S queue management, the AP dynamically creates and removes L4S queues based on identified traffic streams. In the exemplary AP-Driven Classification approach using Mirrored-SCS (MSC) for enabling L4S in WLANs, in accordance with various embodiments of the present invention, with regard to L4S traffic prioritization, classified L4S traffic receives low-latency scheduling (preferential treatment) using appropriate 802.11 mechanisms (e.g., EDCA parameters).

Some key points regarding the exemplary AP-Driven Classification approach using Mirrored-SCS (MSC) for enabling L4S in WLANs, in accordance with various embodiments of the present invention, will now be presented. This approach leverages the existing MSCS framework for stream identification while addressing its limitations for L4S traffic with a custom QoS assignment strategy. The dynamic queue management and low-latency scheduling ensures efficient handling of L4S traffic flows.

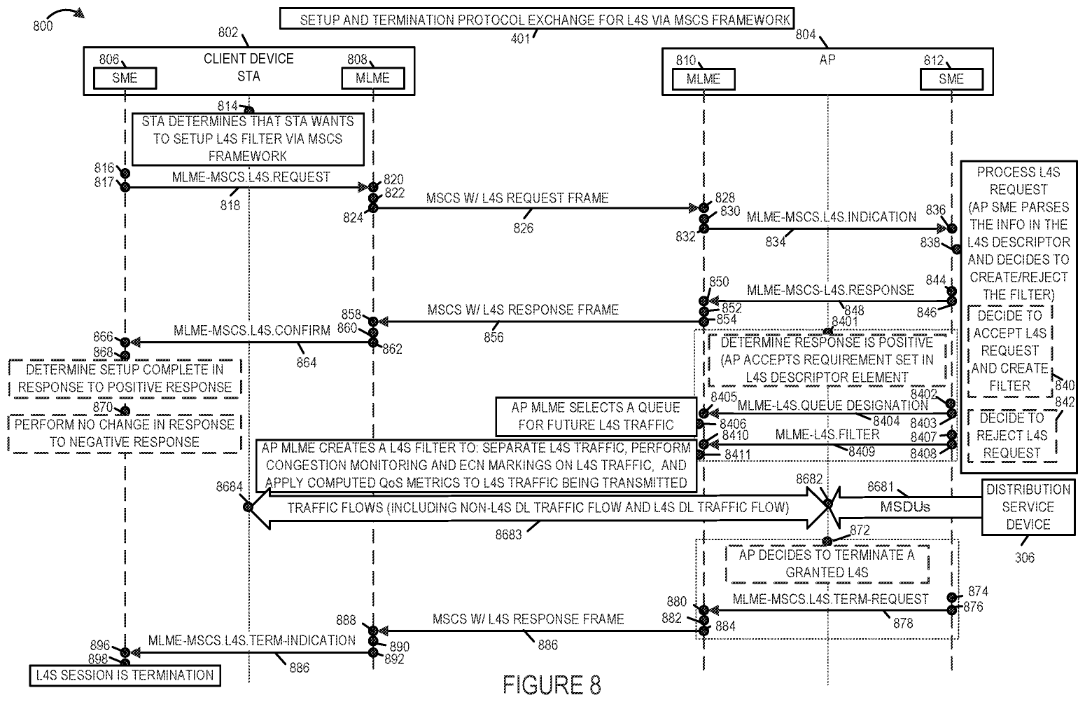

FIG. 8 is a signaling diagram 800, which illustrates an exemplary setup and termination protocol exchange for L4S over MSCS framework, as indicted by title information block 801, in accordance with an exemplary embodiment. FIG. 8 includes exemplary client device station (STA) 802 and exemplary access point (AP) 804. Exemplary client device STA 802 is, e.g., any of the STAs of system 300 of FIG. 3, and AP 804 is, e.g. any of the APs of system 300 of FIG. 3. For example, STA 802 is, e.g. STA 1A 320 of system 300 of FIG. 1 and AP 804 is AP 1 302 of system 300 of FIG. 1. STA 802 and AP 804 support a version of MSCS which supports L4S, in accordance with features of the present invention. STA 802 includes station management entity (SME) 806 and MAC sublayer management entity (MLME) 808. AP 804 includes MLME 810 and SME 812.

In step 814 STA 802 decides that it wants to set up an L4S filter. In response to the decision to set up the L4S filter, in step 816 the SME 806 of STA 802 generates MLME-MSCS.L4S.Request 818. In step 817 the SME 806 of STA 802 sends the generated MLME-MSCS.Request 818 to MLME 808 of STA 802. In step 820, MLME 808 of STA 802 receives the MLME-MSCS.Request 818 and recovers the communicated information. In step 822, MLME 808 of STA 802, in response to the received MLME-MSCS.Request 818, generates MSCS w/L4S Request frame 826 in step 822 and sends, in step 824 the MSCS w/L4S Request frame 826 to AP 804. Thus, in step 824, STA 802 sends, e.g., transmits, MSCS w/L4S request frame 826 to AP 804.

In step 828, AP 804, including MLME 810, receives the MSCS w/L4S Request frame 826. In response to MLME 810 of AP 804 receiving the MSCS w/l4S request frame, MLME 810 generates and sends MLME-MSCS.L4S. Indication 834 to SME 814 of AP 804. In step 836 the SME 812 of AP 804 receives the MLME-MSCS.L4S. Indication 834. In response to the received MLME-MSCS.L4S. Indication 834, in step 838 SME 812 of AP 804 processes the L4S request communicated in the MLME-MSCS.L4S. Indication 834, e.g., the AP SME 812 parses the information in the L4S descriptor and decides to create or reject the filter. Step 838 includes steps 840 and 842, and one of steps 840 and 842 is performed for each iteration of step 838. In step 840 the AP SME 812 decides to accept the L4S request and create an L4S filter, in accordance with the request. In step 842 the AP SME 812 decides to reject the L4S request.

Operation proceeds from step 840, when performed to step 8401, in which the AP 8401 determines that the response is positive, e.g., the AP 804 accepts the requirement set in the L4S descriptor element, and operation proceeds to step 8402 and step 8407. In step 8402 SME 814 generates MLME-L4S.QueueDesignation 8404, and in step 8403 SME 812 sends MLME-L4S.QueueDesignation 8404 to the MLME 810 of the AP 804, which the MLME 810 receives in step 8405. In step 8406, the MLME 810, in response to the received MLME-L4S.QueueDesignation 8404, selects (e.g., designates) a queue for future L4S traffic. Thus, in step 810 the AP 804 selects and assigns one of its queues to be a L4S queue (for downlink L4S traffic). Thus, the AP 804 will have a queue for DL L4S traffic and a queue for DL non-L4S (regular) traffic.

In step 8407 SME 814 generates MLME-L4S.Filter 8409, and in step 8408 SME 812 sends MLME-L4S.Filter 8409 to MLME 810 of the AP 804, which the MLME 810 receives in step 8410. In step 8411, the MLME 810, in response to the received MLME-L4S.Filter 8404, creates a filter, referred to as an L4S filter, to separate L4S traffic from regular (non-L4S traffic), to implement congestion monitoring on the L4S buffer (queue) and to apply computed QoS metrics for L4S traffic, e.g., based on AP monitored traffic. The L4S filter is created in step 8411, in accordance with the AP accepted L4S descriptor element requirements communicated in the received L4S request frame and will be used to process received MSDUs from a distribution service to identify which MSDUs are conveying L4S data. In some embodiments creating the L4S filter includes monitoring uplink traffic streams; detecting uplink traffic streams having parameters relating to L4S traffic; designating downlink traffic streams corresponding to the detected uplink traffic streams as downlink L4S traffic streams; obtaining stream ID information corresponding to the downlink L4S traffic streams; and using the obtained stream ID information in the L4S classifier filter to identify L4S MSDUs (e.g., via stream ID comparisons and matching).

In step 844, the SME 812 of AP 804 generates MLME-MSCS.L4S response 848, which includes the decision of step 838, e.g., accept or reject, and in step 846 sends MLME-MSCS.L4S response 848 to MLME 810 of the AP 804. In step 850 the MLME 810 of AP 804 receives the MLME-MSCS.L4S.response 848, and in response to the received MLME-MSCS.L4S response 848, in step 852 MLME 810 of AP 804 generates a MSCS w/L4S Response frame 856, which includes the accept/reject decision. In step 854 the AP 804 sends the MSCS w/L4S Response frame 856 to the MLME 808 of the STA 802. In this way AP 804 communicates the MSCS w/L4S Response frame 856 to STA 802.

In step 858 the MLME 808 of STA 802 receives the MSCS w/L4S Response frame 856, and in response, in step 860 the MLME generates a MLME-MSCS.L4S.confirm 864, which includes an indication of accept or reject, and in step 862 sends the MLME-MSCS.L4S.confirm 864 to the SME 806. In step 866, the SME 806 receives the MLME-MSCS.L4S and recovers the communicated information, e.g., identifying whether the response was positive or negative. If the received response is positive, then operation proceeds from step 866 to step 868, in which the SME 806 of STA 802 determines that the setup is complete, e.g., STA 802 determines that AP 804 has implemented the requested L4S filter. However, if the received response is negative, then operation proceeds from step 866 to step 870, in which the SME 806 of STA 802 performs no change in response to the negative response, e.g., STA 802 recognizes that AP 804 has rejected its L4S filter request, and STA 802 recognizes that AP 804 will not be separating its downlink traffic into L4S traffic and non-L4S (regular) traffic.

Consider that AP 804 has decided to accept the L4S request, e.g., step 840 was executed, AP 804 designated a queue for L4S traffic in step 8406 and the AP 804 created a L4S filter, in accordance with STA generated L4S descriptor element, communicated in MSCS w/L4S request frame 826. AP 804 receives MSDUs 8681 from distribution service device 306 and performs operations 8682 including performing filtering in accordance with the generated L4S filter, which results in traffic flows 8683 including a non-L4S DL traffic flow and a L4S DL traffic flow. Operation 8682 includes, e.g., steps in flowchart 1100 starting at step 1103 and proceeding forward through the flow toward steps 1124/1125. Multiple iterations of the flow starting at step 1103 are performed, e.g., as multiple received MDUs are received and processed.

In step 872 AP 804 decides to terminate the granted L4S. In response to the L4S termination determination, in step 874 SME 812 of AP 804 generates MLME-MSCS.L4S. TERM-request 878 and in step 876 sends the generated MLME-MSCS.L4S. TERM-request 878 to MLME 810 of AP 804. In step 880, MLME 810 receives the MLME-MSCS.L4S. TERM-request 878, and in response to the reception, in step 882 MLME 810 of AP 804 generates a MSCS w/L4S response frame 886. In step 884 AP 804 sends the generated MSCS w/L4S response frame 886 to the MLME of STA 802. In step 888 the MLME 808 of STA 802 receives the MSCS w/L4S Response frame 888, which is an unsolicited MSCS w/L4S response frame. In step 890 the MLME 808, in response to receiving an unsolicited MSCS w/L4S response frame, generates a MLME-MSCS.L4S TERM-Indication, and in step 892 MLME 892 sends the MLME-MSCS.L4S TERM-Indication 894 to the SME 806 of STA 802. In step 896 the SME 806 of STA 802 receives the MLME-MSCS.L4S TERM-Indication 894, and, in response, in step 894 the L4S session is terminated.

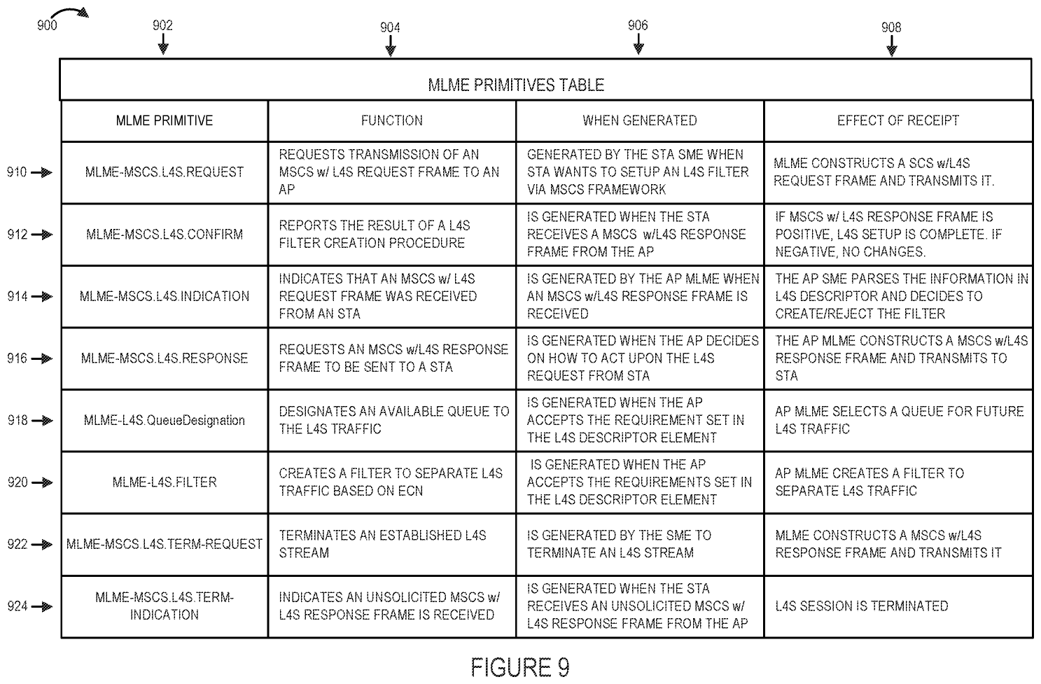

FIG. 9 is a table 900 illustrating exemplary novel MLME primitives (for MSCS), used to support L4S, in accordance with an exemplary embodiment. Table 900 provides information regarding the primitives included in the exemplary signaling diagram 800 of FIG. 8. First column 902 lists the primitives. Second column 904 describes the function for each primitive. Third column 906 includes information indicating when the primitive is generated. Fourth column 908 indicates the effect of receipt of the primitive. First row 910 includes information corresponding to the MLME primitive designated as MLME-MSCS.L4S.Reqeust. Second row 912 includes information corresponding to the MLME primitive designated as MLME-MSCS.L4S.Confirm. Third row 914 includes information corresponding to the MLME primitive designated as MLME-MSCS-L4S. Indication. Fourth row 916 includes information corresponding to the MLME primitive designated as MLME-MSCS.L4S.Response. Fifth row 918 includes information corresponding to the MLME primitive designated as MLME-L4S.QueueDesignation. Sixth row 920 includes information corresponding to the MLME primitive designated as MLME-L4S.Filter. Seventh row 922 includes information corresponding to the MLME primitive designated as MLME-MSCS.L4S.TERM-request. Eighth row 924 includes information corresponding to the MLME primitive designated as MLME-MSCS.L4S.TERM-Indication.

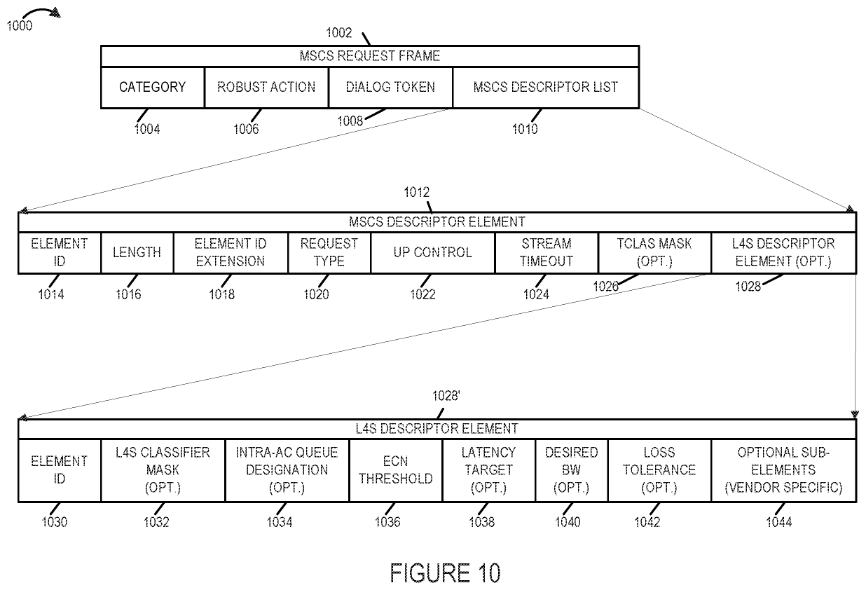

FIG. 10 is drawing 1000 illustrating an exemplary MSCS request frame format used for a MSCS request frame 1002, in accordance with an exemplary embodiment, said MSCS request frame 1002 including a novel L4S descriptor element 1028′, included as part of a MSCS descriptor element 1012, included as part of a MSCS descriptor list 1010 in the MSCS request frame 1002.

Exemplary MSCS request frame 1002 includes a category portion 1004, a robust action portion 1006, a dialog token portion 1008 and a MSCS descriptor list portion 1010. The MSCS descriptor list portion 1010 includes one or more MSCS descriptor elements 1012. An MSCS descriptor element 1012 includes an element ID portion 1014, a length portion 1016, an element ID extension portion 1018, a request type portion 1020, an UP control portion 1022, a stream timeout portion 1024, a TCLAS mask (optional) portion 1026, and a L4S descriptor element (optional) portion 1028. L4S descriptor element 1028′ is, e.g., L4S descriptor element 1028. L4S descriptor element 1028′ includes an element ID portion 1030, a L4S classifier mask (optional) portion 1032, an Intra-AC queue designation (optional) portion 1034, a ECN threshold portion 1036, a latency target (optional) portion 1038, a desired bandwidth (BW) (optional) portion 1040, a loss tolerance (optional) portion 1042, and an optional sub-elements (vendor specific) portion 1044.

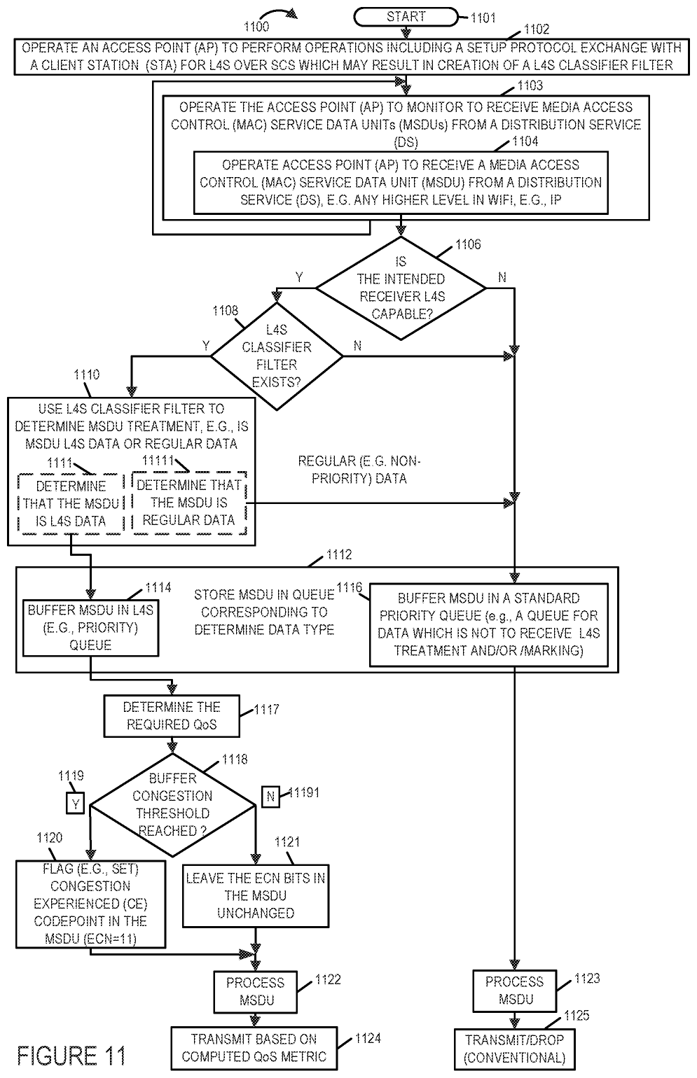

FIG. 11 is a flowchart of an exemplary method of operating an access point (AP) in accordance with an exemplary embodiment. The AP implementing the method of flowchart 700 is, e.g., any of AP 1 302 of FIG. 3, AP N of FIG. 3, or AP 804 of FIG. 8. Operation of the exemplary method starts in step 701, in which the AP is powered on and initialized. Operation proceeds from start step 1101 to step 1102. In step 1102 the access point, e.g., AP 804, is operated to perform operations including a setup protocol exchange with a client station (STA), e.g., client STA 802, for L4S over MSCS, which may result in creation of a L4S classifier filter, e.g., AP 804 performs steps 828, 830, 832, 836, 838, 840, 8401, 8402, 8403, 8405, 8406, 8407, 8408, 8410, 8411, 844, 846, 850, 852 and 854, of signaling diagram 800 resulting of signaling diagram 800 resulting in L4S filter establishment in step 8411. Operation proceeds from step 1102 to step 1103.

In step 1103, the AP monitors to receive media access control (MAC) service data units (MSDUs) from a distribution service, e.g., distribution service device 306. Step 1103 is performed repetitively, on an ongoing basis. Step 1103 includes step 1104, in which the AP receives a MSDU from a distribution service, e.g., at any higher level in WiFi, e.g. at the IP level. In response to the reception of a MSDU in step 1104, operation proceeds from step 1104 to step 1106.

In step 1106, the AP determines if the intended receiver, e.g., the intended STA corresponding to the received MSDU, is L4S capable. If the determination is that the intended receiver is L4S capable then operation proceeds from step 1106 to step 1108; otherwise, operation proceeds from step 1106 to step 1116.

In step 1108 the AP determines whether or not a L4S classifier filter exists, e.g., the AP determines whether or not it has a created L4S classifier filter, corresponding to the STA, which is the intended recipient of the received MSDU. If the determination of step 1108 is that the AP does not have a L4S classifier filter, then operation proceeds from step 1108 to step 1116. However, if the determination is that the AP has a L4S classifier filter, then operation proceeds from step 1108 to step 1110.

In step 1110 the AP uses the L4S classifier filter to determine MSDU treatment, e.g., is the MSDU conveying L4S data or regular data. Step 1110 includes step 1111 and step 11111, one of which is executed for each iteration of step 1110.

In step 1111 the AP determines that the MSDU is L4S data, and operation proceeds from step 1111 to step 1114 of step 1112. Alternatively, in step 11111, the AP determines that the MSDU is regular data, and operation proceeds from step 11111 to step 1116 of step 1112.

In step 1112 the AP stores the MSDU in a queue corresponding to the determined data type. In step 1114, the AP stores, e.g. buffers, the MDSU in a L4S (e.g., priority) queue, and operation proceeds from step 1114 to step 1117. Alternatively, in step 1116, the AP stores, e.g., buffers, the MSDU in a standard priority queue (e.g., a queue for data which is not to receive L4S treatment and/or marking), and operation proceeds from step 1116 to step 1123.

Returning to step 1117, the AP determines the required QoS. Operation proceeds from step 1117 to step 1118.

In step 1118 the AP determines if a buffer congestion threshold for the L4S queue (buffer) has been reached. If the determination is that the buffer congestion threshold has been reached, as indicated by Y 1119, then operation proceeds from step 1118 to step 1120, in which the AP flags, e.g. sets, a congestion experienced (CE) codepoint in the MSDU, e.g., the AP sets the ECN bits (ECT, CE)=pattern (11), in the ECN field of the header of the MSDU indicating congestion experienced. Alternatively, if the determination is that the buffer congestion threshold has not been reached, as indicated by N 11191, then operation proceeds from step 1118 to step 1121, in which the AP leaves the ECN bits in the MSDU unchanged.

Operation proceeds from step 1120 or step 1121 to step 1122, in which the AP processes the MSDU. Operation proceeds from step 1122 to step 1124, in which the AP transmits the MSDU based on computed QoS metric.

Returning to step 1123, in step 1123 the AP processes the MSDU. Operation proceeds from step 1123 to step 1125, in which the AP transmits or drops the MSDU, using the conventional approach.

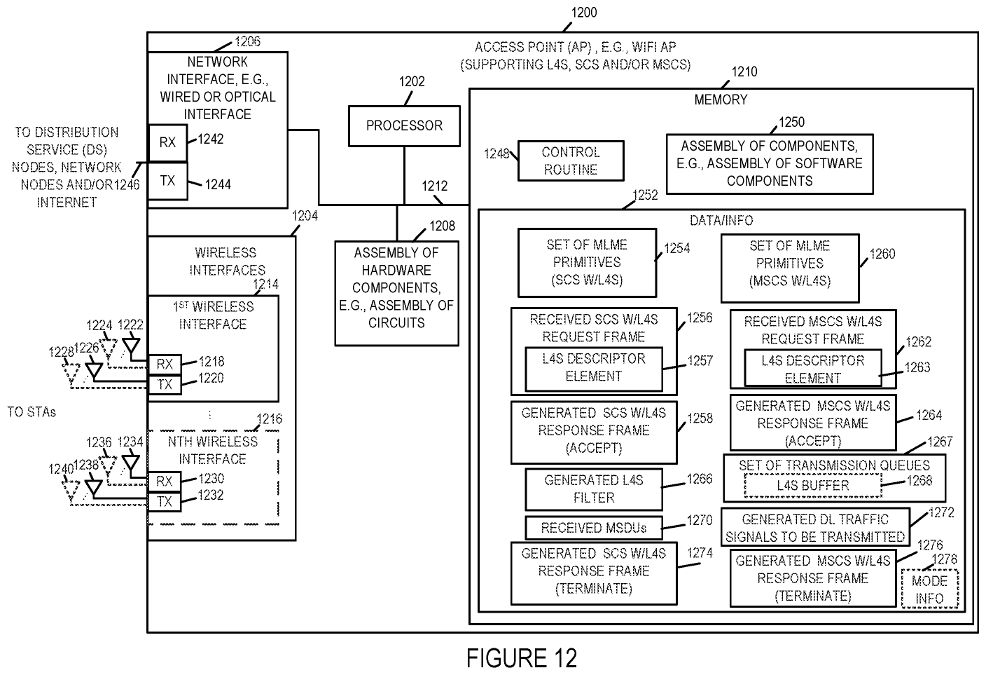

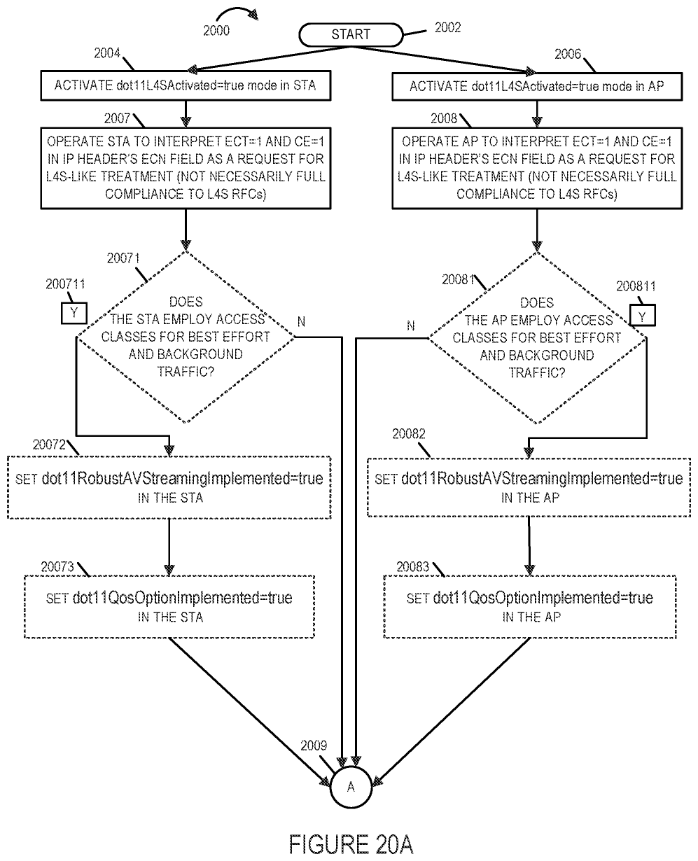

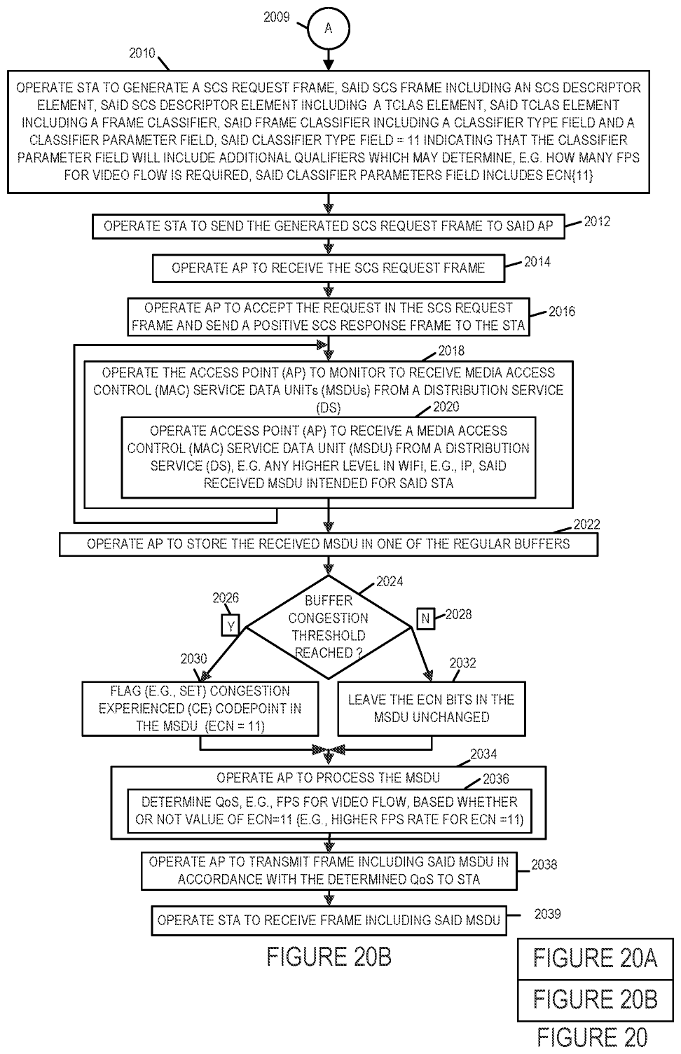

FIG. 12 is a drawing of an exemplary access point (AP) 1200 in accordance with an exemplary embodiment, said exemplary AP supporting a version of SCS which includes support for L4S and/or supporting a version of MSCS which includes support for L4S. Exemplary access point 1200 is, e.g., AP 1 302 or AP N 304 of system 300 of FIG. 3, AP 404 of FIG. 4, AP 804 of FIG. 8, an AP implementing steps of the exemplary method of flowchart 700 of FIG. 7, an AP, implementing steps of the exemplary method of flowchart 1100 of FIG. 11, and/or an AP implementing steps of the exemplary method of flowchart 20 of FIG. 20. Exemplary access point (AP) 600 includes a processor 1202, e.g., a CPU, wireless interfaces 1204, network interface 1206, assembly of hardware components 1208, e.g., an assembly of circuits, and memory 1210 coupled together via a bus 1212 over which the various elements may interchange data and information.

Wireless interfaces 1204 includes one or more wireless interfaces (1st wireless interface 1214, . . . , Nth wireless interface 1216). In some embodiments one or more of the wireless interfaces included in wireless interfaces 1204 are WiFi wireless interfaces. Different wireless interfaces included in wireless interfaces 1204 may correspond to different frequency bands, different communications protocols and/or different communications technologies. 1st wireless interface 1214 includes wireless receiver 1218 and wireless transmitter 1220. Wireless receiver 1218 is coupled to one or more antennas or antennas elements (1222, . . . , 1224) via which the access point 1200 receives wireless signals from stations (STAs). Wireless transmitter 1220 is coupled to one or more antennas or antennas elements (1226, . . . , 1228) via which the access point 1200 transmits wireless signals to STAs. Nth wireless interface 1216 includes wireless receiver 1230 and wireless transmitter 1232. Wireless receiver 1230 is coupled to one or more antennas or antennas elements (1234, . . . , 1236) via which access point 1200 receives wireless signals from STAs. Wireless transmitter 1232 is coupled to one or more antennas or antennas elements (1238, . . . , 1240) via which the access point 1200 transmits wireless signals to STAs. Exemplary wireless signals transmitted by access point 1200 include, e.g., a SCS w/L4S response frame, a MSCS w/L4S response frame, DL traffic signals conveying a L4S data frame, and DL traffic signals conveying a non-L4S data frame. Exemplary wireless signals received by access point 1200 include a SCS w/L4S Request frame, a MSCS w/L4S Request frame, uplink data traffic signals.

Network interface 1206, e.g., a wired or optical interface, includes receiver 1242, transmitter 1244 and connector 1246 coupled together. Network interface 1206 couples the access point 1200 to a distribution service, e.g., distribution service 306 of system 300 of FIG. 3, other network nodes and/or the Internet.

Memory 1210 includes control routine 1248, assembly of components 1250, e.g., an assembly of software components, and data/information 1252. Control routine 1248 includes instructions which when executed by processor 1202 control the access point 1200 to implement basic operational functions, e.g., read memory, write to memory, control an interface, load a program, subroutine, or app, etc. Assembly of components 1250, e.g., an assembly of software components, e.g., routines, subroutines, applications, etc., includes, e.g., code, e.g., machine executable instructions, which when executed by processor 1202, controls the AP 1200 to implement steps of a method, e.g., steps of a method which are performed by AP 404 implementing steps of the method of signaling diagram 400 of FIG. 4, steps of the method of flowchart 700 of FIG. 7, steps of a method which are performed by AP 804 implementing steps of the method of signaling diagram 800 of FIG. 8, steps of the method of flowchart 1100 of FIG. 11, and/or steps of the method of flowchart 2000 of FIG. 20 which are implemented by an AP.

Data/information 1252 includes, in some embodiments, a set of MLME primitives 1254 for supporting SCS w/L4S (See FIG. 5), a received SCS w/L4S request frame 1256 including a L4S descriptor element 1257 (See FIG. 6), a generated SCS w/L4S response frame 1258, e.g., indicating accept, and a generated SCS w/L4S response frame 1274, e.g., an unsolicited response frame to be sent to indicate to a STA that the previously granted SCS w/L4S request is being revoked. In some embodiments, data/information 1252 includes a set of MLME primitives 1260 for supporting MSCS w/L4S (See FIG. 9), a received MSCS w/L4S request frame 1262 including a L4S descriptor element 1263 (See FIG. 10), a generated MSCS w/L4S response frame 1264, e.g., indicating accept, and a generated MSCS w/L4S response frame 1276, e.g., an unsolicited response frame to be sent to indicate to a STA that the previously granted MSCS w/L4S request is being revoked. Data/information 1252 includes a generated L4S filter 1266, set of transmission queues 1267 (sometimes referred to as transmission buffers), which may, and in some embodiments, does include an L4S buffer 1268 (sometimes referred to as an L4S queue), received MSDUs 1270 to be processed, and generated DL traffic signals 1272 to be transmitted, e.g., including a DL traffic data frame conveying L4S data and a DL traffic data frame conveying non-L4S traffic data. In some embodiments data/information 1252 further includes mode information 1278, e.g., information indicating whether or not the AP 1200 is in a WiFi L4S mode of operation, whether or not AP 1200 is in a WiFi Robust AV Streaming Implemented mode of operation and whether or not AP 1200 is in a WiFi QoS Option Implemented mode of operation.

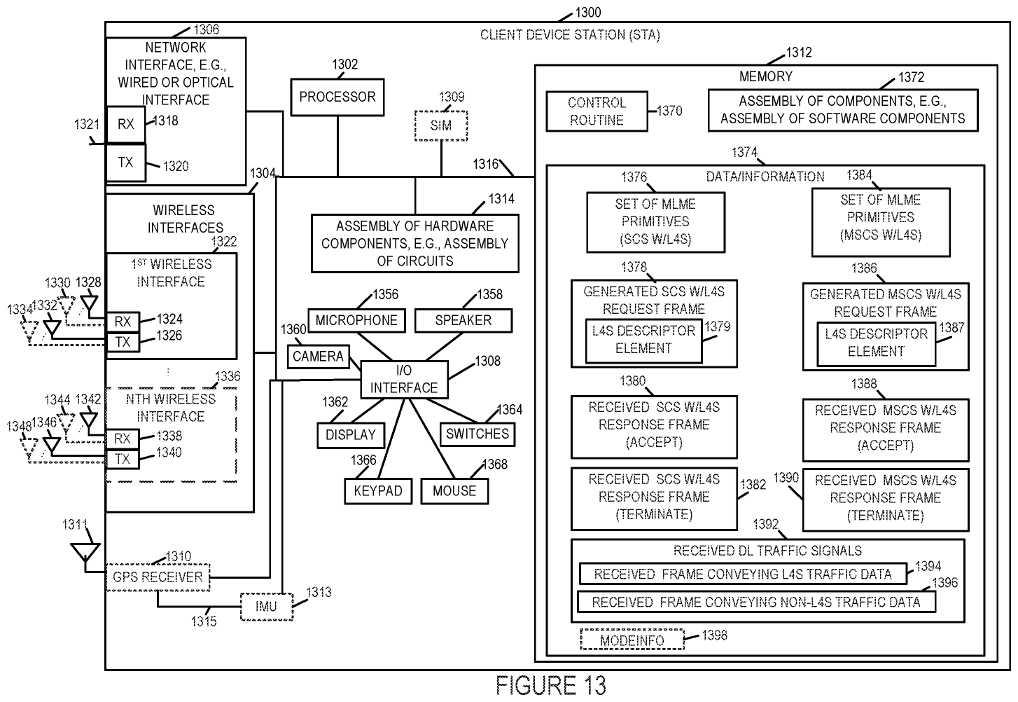

FIG. 13 is a drawing of an exemplary client device station (STA) 1300 in accordance with an exemplary embodiment, said exemplary STA supporting a version of SCS which includes support for L4S and/or supporting a version of MSCS which includes support for L4S. STA 1300 is, e.g., any of the STAs (320, 322, 324, 326, 328, 330) of system 300 of FIG. 3, STA 402 of FIG. 4, and/or STA 802 of FIG. 8, a STA interacting with the AP implementing the steps of flowchart 70000 of FIG. 7, a STA interacting with the AP implementing the steps of flowchart 1100 of FIG. 11, and/or a STA implementing steps of the flowchart 2000 of FIG. 20.

Exemplary STA 1300 includes a processor 1302, e.g., a CPU, wireless interfaces 1304, a network interface 1306, an I/O interface 1308, a subscriber identity module (SIM) card 1309, a GPS receiver 1310, an inertial measurement unit (IMU) which includes gyroscopes and accelerometers, e.g., an IMU on a chip, memory 1312, and an assembly of hardware components 1314, e.g., an assembly of circuits, coupled together via a bus 1316 over which the various elements may interchange data and information.

Wireless interfaces 1304 includes one or more wireless interfaces (1st wireless interface 722, . . . , Nth wireless interface 1336). In some embodiments wireless interfaces 1304 includes one or more WiFi wireless interfaces. Different wireless interfaces included in wireless interfaces 704 may correspond to different frequency bands, different communications protocols and/or different communications technologies. 1st wireless interface 1322 includes wireless receiver 1324 and wireless transmitter 1326. Wireless receiver 1324 is coupled to one or more antennas or antennas elements (1328, . . . , 1330) via which the STA 1300 receives wireless signals from access points. Wireless transmitter 1326 is coupled to one or more antennas or antennas elements (1332, . . . , 1334) via which the STA 1300 transmits wireless signals to access points. Nth wireless interface 1336 includes wireless receiver 1338 and wireless transmitter 1340. Wireless receiver 1338 is coupled to one or more antennas or antennas elements (1342, . . . , 1344) via which the STA 1300 receives wireless signals from access points. Wireless transmitter 1340 is coupled to one or more antennas or antennas elements (1346, . . . , 1348) via which the STA 1300 transmits wireless signals to access points. In some embodiments one or more of the same antennas or antenna elements are used by a wireless receiver and a wireless transmitter. Exemplary wireless signals transmitted by STA include, e.g., a SCS w/L4S Request frame, a MSCS w/L4S Request frame, and uplink data traffic signals. Exemplary wireless signals received by STA 1300 include e.g., a SCS w/L4S response frame, a MSCS w/L4S response frame, DL traffic signals conveying a L4S data frame, and DL traffic signals conveying a non-L4S data frame.

Network interface 1306, e.g., a wired or optical interface, includes receiver 1318, transmitter 1322 and connector 1321 coupled together. Network interface 1306 allows the STA 1300 to be coupled to network nodes and/or the Internet, via a wireline interface connection, when available.

GPS receiver 1310 is coupled to GPS antenna 1310 via which the STA 1300 receives GPS signals from satellites. IMU 1313 is coupled to GPS receiver 1310 via connection 1315. The GPS receiver 1310 determines time, position, and velocity information based on the received GPS signals. In some embodiments, the GPS receiver 1310 and/or the processor 1302 uses IMU 1313 measurement information in addition to the received GPS signals to determine time, position, velocity information, and or other navigation information. For example, the GPS receiver 1313 and/or processor 1302 uses the IMU information to aid determination of STA location, when GPS reception is unavailable or of low quality. The SIM card 1309, GPS receiver 1310 and IMU 1313 are optional elements which may or may not be included in STA 1300.

STA 1300 further includes a plurality of I/O devices (microphone 1356, speaker 1358, camera 1360, display 1362, e.g. a touch screen display, switches 1364, keypad 1366 and mouse 1368) coupled to I/O interface 1308, via which the various I/O devices may interface with other elements within STA 1300.

Memory 1312 includes control routine 1370, assembly of components 1372, e.g., an assembly of software components, and data/information 1344. Control routine 1370 includes instructions which when executed by processor 1302 control the STA 1300 to implement basic operational functions, e.g., read memory, write to memory, control an interface, load a program, subroutine, or app, etc. Assembly of components 1372, e.g., an assembly of software components, e.g., routines, subroutines, applications, etc., includes, e.g., code, e.g., machine executable instructions, which when executed by processor 1302, controls the STA 1300 to implement steps of a method, e.g., steps of a method which are performed by STA 402 implementing steps of the method of signaling diagram 400 of FIG. 4, steps of a method which are performed by STA 802 implementing steps of the method of signaling diagram 800 of FIG. 8, and/or steps of the method of flowchart 2000 of FIG. 20 which are implemented by a STA.

Data/information 1374, in some embodiments, includes a set of MLME primitives 1376 which support SCS w/L4S (See FIG. 5), a generated SCS w/L4S request frame 1378 including a L4S descriptor element (See FIG. 6), a received SCS w/L4S response frame 1380, e.g., indicating accept, and a received SCS w/L4S response frame 1382, e.g., indicating terminate. Data/information 1374, in some embodiments, includes a set of MLME primitives 1384 which support MSCS w/L4S (See FIG. 9), a generated MSCS w/L4S request frame 1386 including a L4S descriptor element (See FIG. 10), a received MSCS w/L4S response frame 1388, e.g., indicating accept, and a received SCS w/L4S response frame 1390, e.g., indicating terminate. Data/information 1374 further includes received downlink (DL) traffic data signals 1392. The received DL traffic data signals 1392 includes a received frame 1394 conveying L4S traffic data and a received frame 1396 conveying non-L4S (e.g., regular) traffic data. In some embodiments data/information 1374 further includes mode information 1398, e.g., information indicating whether or not the STA 1300 is in a WiFi L4S mode of operation, whether or not AP 1300 is in a WiFi Robust AV Streaming Implemented mode of operation and whether or not STA 1300 is in a WiFi QoS Option Implemented mode of operation.

Some embodiments, in accordance with the present invention, enable proper treatment for the Low Latency Traffic by introducing and using a new mode of operation within the existing SCS framework, e.g., without the need to implement separate queues for L4S support.

Implementing separate queues for L4S support in Wi-Fi hardware presents significant practical challenges. In some exemplary embodiments, in accordance with the present invention, existing SCS is leveraged for providing L4S support. Existing SCS enables classification of traffic flows based on Differentiated Services Code Point (DSCP) markings. The problem with current SCS is that the interpretation by endpoints (Station (STA) & Access Point (AP)) of the Differentiated Service Code Point (DSCP) markings is not guaranteed.

Solutions, in accordance with the present invention, include one or both of the following features described below. Feature 1): Some embodiments, in accordance with the present invention, change user priority (UP)<->access category (AC) mapping in existing spec by adding {A_BE and A_BK} for when {dot11RobustAVStreamingImplemented=true, and dot11AlternateEDCAActivate=true}. Feature 2: Some embodiments, in accordance with the present invention, utilize the existing Soft SCS framework, but with a new mode, dot11L4SActivated=true, to identify and prioritize low-latency traffic without extensive hardware modifications.

Presently, IEEE 802.11 standards specify two {A_VO, A_VI} of the four access classes for which Robust AV streaming features (for which SCS mechanism was originally defined) features apply. P802.11-REVme/D5.0, February 2024-IEEE Draft Standard for Information Technology—Telecommunications and Information Exchange Between Systems Local and Metropolitan Area Networks—Specific Requirements-Part 11: Wireless Local Area Network (LAN) Medium Access Control (MAC) and Physical Layer (PHY) Specifications is a proposed revision to the 802.11 specifications which is hereby expressly incorporated by reference. Albeit not explicitly mentioned, a hint is provided in IEEE 802.11me specifications Table 9-196, Table 9-197 etc. of which, {A_VO} is not generally considered as queue building traffic, but the two ACs which do have the potential to carry queue building traffic A_BE, A_BK are considered.

As applicability of L4S mechanisms is primarily for queue-building traffic, it stands to reason to avail {A_BE, A_BK} of mechanisms provided via Robust AV streaming features (SCS and its derivates).

Hence, in some embodiments, in accordance with the present invention, when a STA employs access classes for best effort traffic and background traffic namely {A_BE and A_BK} then it sets {dot11RobustAVStreamingImplemented=true, and dot11AlternateEDCAActivate=true}. An exemplary resulting IEEE 802.11 specification change for STA may appear as indicated below:

### 11.25.1 Robust AV Streaming Dependencies:

When dot11RobustAVStreamingImplemented is true, the STA is a robust AV streaming STA. The attribute dot11QosOptionImplemented shall be true in a robust AV streaming STA. Both dot11RobustAVStreamingImplemented and dot11QosOptionImplemented may also be set to true if STA recognizes low-latency low-loss scalable (L4S) markings.

Similarly, in some embodiments, an AP's support of Robust AV streaming as well is facilitated and implemented. An exemplary resulting IEEE 802.11 specification change for AP may appear like so:

### Robust AV Streaming Dependencies:

When dot11RobustAVStreamingImplemented is true, the AP is a robust AV streaming AP. The attribute dot11QosOptionImplemented shall be true in a robust AV streaming AP. Both dot11RobustAVStreamingImplemented and dot11QosOptionImplemented may also be set to true if AP recognizes low-latency low-loss scalable (L4S) markings.

In some embodiments, in accordance with the present invention, a dot11L4SActivated=true mode is introduced into the existing SCS framework, implemented and used. Together with the above mentioned feature (changing user priority (UP)<->access category (AC) mapping in existing spec by adding {A_BE and A_BK} for when {dot11RobustAVStreamingImplemented=true, and dot11AlternateEDCAActivate=true}), this allows proposed treatment on a per Access Class basis (including Access Classes handling queue-building traffic).

A new mode, referred to as dot11L4SActivated=true mode, is introduced into the existing SCS framework. When this new mode is activated: STA and AP understand ECT=1 and CE=1 in the IP header's ECN field as a request for L4S-like treatment (not necessarily full compliance to L4S RFCs). Thus, in this new mode (referred to as dot11L4SActivated=true mode), the bit pattern 11 for the ECN bit pair (ECT, CE) takes on a new meaning.
ECT (ECN Capable Transport): This bit (the leftmost bit) indicates whether the sender can understand and respond to ECN notifications.
CE (Congestion Experienced): This bit (the rightmost bit) is used by routers to inform the receiver if the packet experienced congestion along the transmission path.

Potential Mechanisms (implementation dependent) for LL treatment include:
Dynamic Sub-band Operation (DSO)
Secondary channel access
Preemption, etc.

Benefits of the proposed solution of implementing and using the new mode dot11L4SActivated=true mode include the following: i) leverages existing SCS framework; ii) minimizes hardware modifications; and iii) provides a mechanism for identifying and prioritizing low-latency traffic.

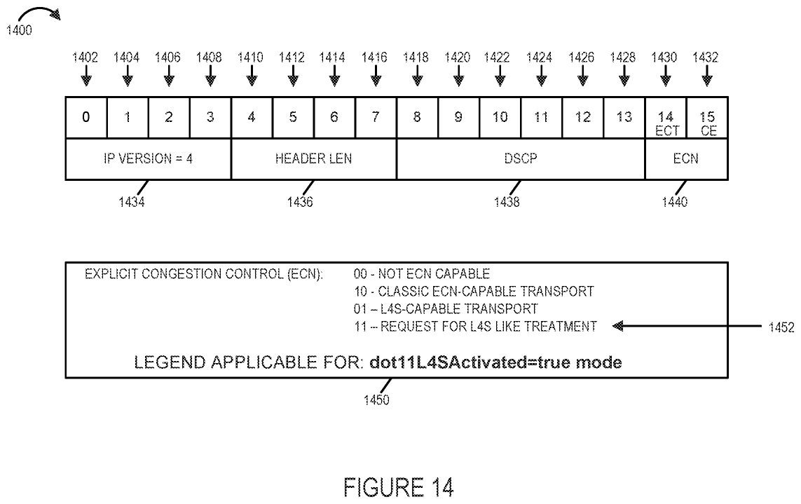

FIG. 14 is a drawing of an exemplary IP header 1400 including an ECN portion 1440 and a legend 1450 illustrating the mapping of ECN bit values for dot11L4SActivated=true mode. IP header 1400 includes 16 bits (Bit 0 1402, Bit 1 1404, Bit 2 1406, Bit 3, 1408, Bit 4 1410, Bit 5 1412, Bit 6 1414, Bit 7 1416, Bit 8 1418, Bit 9 1420 Bit 10 1422, Bit 11 1424, Bit 12 1426, Bit 13 1428, Bit 14 1430, Bit 15 1432). First IP header portion 1434, which includes Bit 0 1402, Bit 1 1404, Bit 2 1406 and Bit 3 1408, is used to convey the IP version, e.g. IP version=4. Second IP header portion 1436, which includes Bit 4 1410, Bit 5 1412, Bit 6 1414 and Bit 7 1416, is used to convey the Header Length (Len). Third IP header portion 1438, which includes Bit 8 1418, Bit 9 1420, Bit 10 1422, Bit 11 1424, Bit 12 1426, and Bit 13 1428, is used to convey Differential Service Code Point (DSCP). Fourth IP header portion 1440 which includes Bit 14 1430, which is the ECT bit, and Bit 15 1432, which is the CE bit, is used to convey the Explicit Congestion control Notification (ECN) bits.

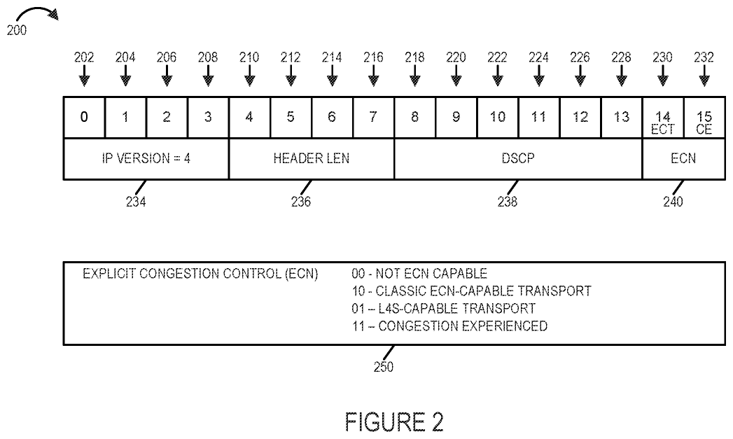

Legend 1450, which is applicable for: dot11L4SActivated=true mode, indicates: ECN bit pattern=00 means not ECN capable; ECN bit pattern=10 means classic ECN-capable transport; ECN bit pattern=01 means L4S-capable transport; and ECN bit pattern=11 means request for L4S like treatment (1452). The mapping of the ECN bits for pattern=11 (used for the dot11L4SActivated=true mode), as shown in FIG. 14, is a different meaning than the convention mapping for ECN bit pattern=11 shown in legend 250 of FIG. 2.

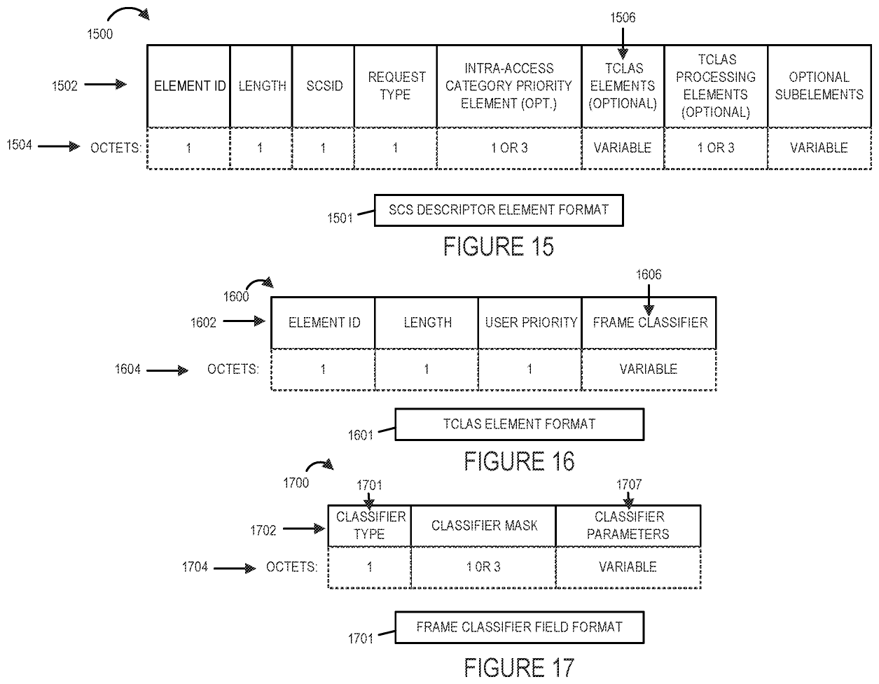

FIG. 15 is a drawing 1500 illustrating an exemplary SCS descriptor element format, as indicated by title box 1501. Row 1502 illustrates the various fields in an SCS descriptor element, and row 1504 identifies the size, in octets, of each of the fields. The SCS descriptor element includes a 1 octet Element ID field, a 1 octet length field, a 1 octet request type field, a 1 or 3 octet intra-access category element field (which is optional), a 1 variable length Traffic Classification (TCLAS) elements field (which is optional) 1506, a 1 or 3 octet TCLAS processing elements field (which is optional) and a variable length optional sub-elements field.

FIG. 16 is a drawing 1600 illustrating an exemplary TCLAS element format, as indicated by title box 1601. Row 1602 illustrates the various fields in a TLCAS element, and row 1604 identifies the size, in octets, of each of the fields. The TLCAS element includes a 1 octet Element ID field, a 1 octet length field, a 1 octet user priority field, and a variable length frame classifier field 1606.

FIG. 17 is a drawing 1700 illustrating an exemplary frame classifier field format, as indicated by title box 1701. Row 1702 illustrates the various fields in a frame classifier field, and row 1704 identifies the size, in octets, of each of the fields. The frame classifier field includes a 1 octet classifier type field 1706, a 1 or 3 classifier mask field, and a variable length classifier parameters field 1708.

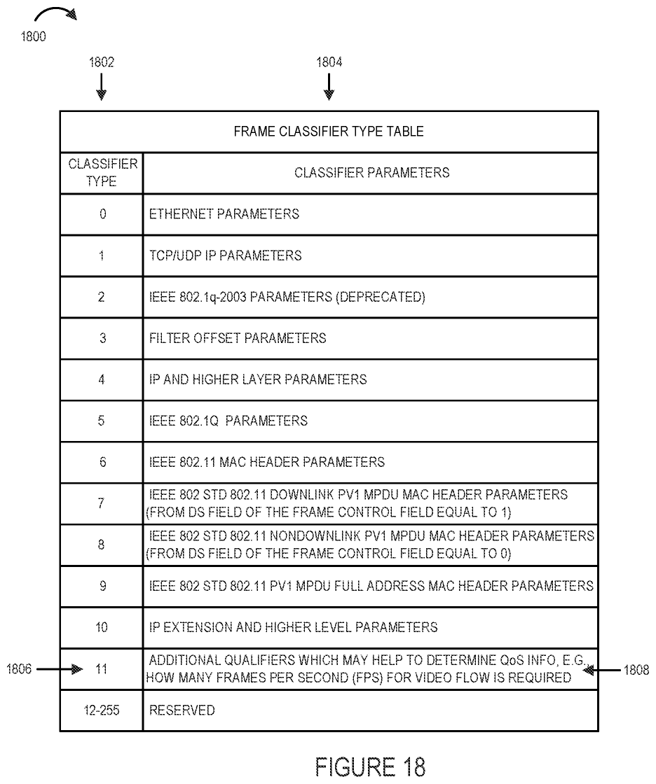

FIG. 18 is a drawing of an exemplary frame classifier type table 1800, in accordance with an exemplary embodiment. Column 1802 includes values corresponding to each classifier type which may be represented. Column 1804 includes classifier parameters corresponding to each classifier type. In accordance with a feature of an exemplary embodiment of the present invention, classifier type 11 (which was previously reserved) has been designated to correspond to a type of classifier parameters, which are additional qualifiers which may be, and sometimes are used, to determine QoS, e.g. how many frames per second (fps) for video is required.

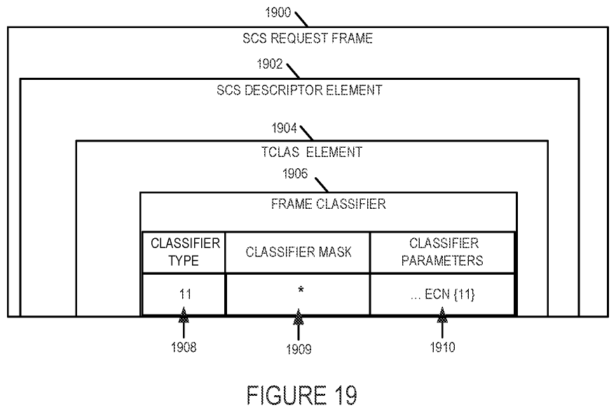

FIG. 19 is a drawing of an exemplary SCS request frame 1900 in accordance with an exemplary embodiment. SCS request frame 1900 includes a SCS descriptor element 1902 which includes a TCLAS element 1904, which includes a frame classifier 1906. The frame classifier 1906 includes a classifier type 11 1908, which signifies that the classifier parameter(s) 1910 are additional qualifiers which may help to determine QoS information, e.g. how many frames per second (fps) for video flow is required, a classifier mask 1909, which can be, and sometimes is, set of enable use of one or more of the classifier parameters, a classifiers parameters 1910, which includes the parameter ECN{11}.

FIG. 20, comprising the combination of FIG. 20A and FIG. 20B, is a flowchart 2000 of an exemplary communications method in accordance with an exemplary embodiment. The communications method of flowchart 2000 may be performed by an access point, e.g., by AP 1 302 of system 300 of FIG. 3, and by a station, e.g., STA 1A 320 of system 300 of FIG. 3. Operation of the exemplary method starts in step 2202, in which the communications system is powered on an initialized, e.g., AP 302 and STA 320 are powered on and initialized. Operation proceeds from start step 2002 to step 2004 and to step 2006. In step 2004 the STA is operated to activate dot11L4SActivated=true mode, and operation proceeds from step 2004 to step 2007, in which the STA is operated to interpret ECT=1 and CE=1 in IP header's ECN field as a request for L4S-like treatment (not necessarily full compliance to L4S RFCs). In step 2006 the AP is operated to activate dot11L4SActivated=true mode, and operation proceeds from step 2006 to step 2008, in which the AP is operated to interpret ECT=1 and CE=1 in IP header's ECN field as a request for L4S-like treatment (not necessarily full compliance to L4S RFCs). Steps 20071, 20072, 20073, 20081, 20082, and 20083 are optional steps, which are included in some embodiments, and bypassed in other embodiments. In some embodiments, steps 20071, 20072, 20073, 20081, 20082, and 20083 are bypassed and operation proceeds from step 2007 and step 2008, via connecting node A 2009 to step 2010.

In some other embodiment, operation proceeds from step 2007 to step 20071 and operation proceeds from step 2008 to step 20081. Returning to step 20071, in step 20071 the STA determines if the STA employs access classes for best effort and background traffic. If the determination of step 20071 is that the STA does employ access classes for best effort and background traffic (as indicated by Y 200711), then operation proceeds from step 20071 to step 20072. In step 20072, the STA sets dot11RobustAVStreamingImplemented=true mode (sometimes referred to as a WiFi Robust AV Streaming Implemented mode) in the STA. Operation proceeds from step 20072 to step 20073, in which the STA sets dot11QosOptionImplemented=true mode (sometimes referred to as a WiFi QoS Option Implemented mode) in the STA. Operation proceeds from step 20073, via connecting node A 2009 to step 2010. Alternatively, if the determination of step 20071 is that the STA does not employ access classes for best effort and background traffic (as indicated by N), then operation proceeds from step 20071, via connecting node A 2009, to step 2010.

Returning to step 20081, in step 20081 the AP determines if the AP employs access classes for best effort and background traffic. If the determination of step 20081 is that the AP does employ access classes for best effort and background traffic (as indicated by Y 200811), then operation proceeds from step 20081 to step 20082. In step 20082, the AP sets dot11RobustAVStreamingImplemented=true mode (sometimes referred to as a WiFi Robust AV Streaming Implemented mode) in the AP. Operation proceeds from step 20082 to step 20083, in which the AP sets dot11QosOptionImplemented=true mode (sometimes referred to as a WiFi QoS Option Implemented mode) in the AP. Operation proceeds from step 20083, via connecting node A 2009, to step 2010. Alternatively, if the determination of step 20081 is that the AP does not employ access classes for best effort and background traffic (as indicated by N), then operation proceeds from step 20081, via connecting node A 2009, to step 2010.

In step 2010 the STA generates a SCS request frame, said SCS request frame including a SCS descriptor element, said SCS descriptor element including a traffic classification (TCLAS) element, said TCLAS element including a frame classifier, said frame classifier including a classifier type field and a classifier parameters field, said classifier type field=11 indicating that the classifier parameter field will include additional qualifiers which may be used to determine QoS information, e.g. how many frames per second (fps) for video flow is required, said classifier parameters field including the parameter ECN{11}. Operation proceeds from step 2010 to step 2012.

In step 2012 the STA sends the generated SCS request frame to said AP, and in step 2014 the AP receives the SCS request frame. Operation proceeds from step 2014 to step 2016, in which the AP accepts the request in the SCS request frame and sends a positive SCS response frame to the STA. Operation proceeds from step 2016 to step 2018.

In step 2018 the AP is operated to monitor to receive media access control (MAC) service data units (MSDUs) from a distribution service, e.g., distribution service 306 of system 300 of FIG. 3. Step 2108 is performed repetitively on an ongoing basis. Step 2018 may, and sometimes does, include step 2020, in which the AP receives a MSDU from a distribution service, e.g., a MSDU in any higher level in WiFi, e.g., IP, said received MSDU intended for said STA. Operation proceeds from step 2020 to step 2022, in which the received MSDU in stored in one of the regular buffers, e.g., one of: a primary voice transmission queue, an alternate voice transmission queue, a primary video transmission queue, an alternate video transmission queue, a best effort transmission queue, or a background transmission queue, e.g., the received MSDU is mapped to and stored into the appropriate transmission queue based on information in the header. Operation proceeds from step 2022 to step 2024. In step 2024, the AP determines if the buffer congestion threshold for the buffer, to which the received MSDU has been stored, has been reached. If the determination of step 2024 is that the buffer congestion threshold for the buffer has been reached, as indicated by Y 2026, then operation proceeds from step 2024 to step 2032, in which the AP flags, e.g., sets, a congestion experienced (CE) codepoint in the MSDU, e.g., the AP sets the ECN bits (ECT, CE)=pattern (11) in the ECN field of the header of the MSDU, indicating congestion experienced. However, if the determination of step 2024 is that the buffer congestion threshold for the buffer has no been reached, as indicated by N 2028, then operation proceeds from step 2024 to step 2032, in which the AP is controlled to leave the ECN bits in the header of the MSDU unchanged. Operation proceeds from step 2030 or step 2032 to step 2304. In step 2034 the AP processes the MSDU. Step 2034 includes step 2036, in which the AP determines QoS information, e.g., a frame per second (fps) rate for video flow based on whether or not the value of the ECN=11 in the header of the MSDU, e.g., the fps for the video stream is changed to a higher fps setting, from the current setting, in response to detecting ECN=11 in the header of the MSDU. Operation proceeds from step 2034 to step 2038 in accordance with the determined QoS, e.g., the AP transmits a frame including the MSDU to the STA at an appropriate fps rate to support L4S-like service. Operation proceeds from step 2038 to step 2039, in which the STA receives the frame including the MSDU. In some embodiments, the MSDU includes an IP packet header including ECN bits set=11. In some such embodiments, both the STA and the AP are operating in: a WiFi L4S mode of operation, a WiFi Robust AV Streaming Implemented mode of operation and a WiFi QoS Option Implemented mode of operation.

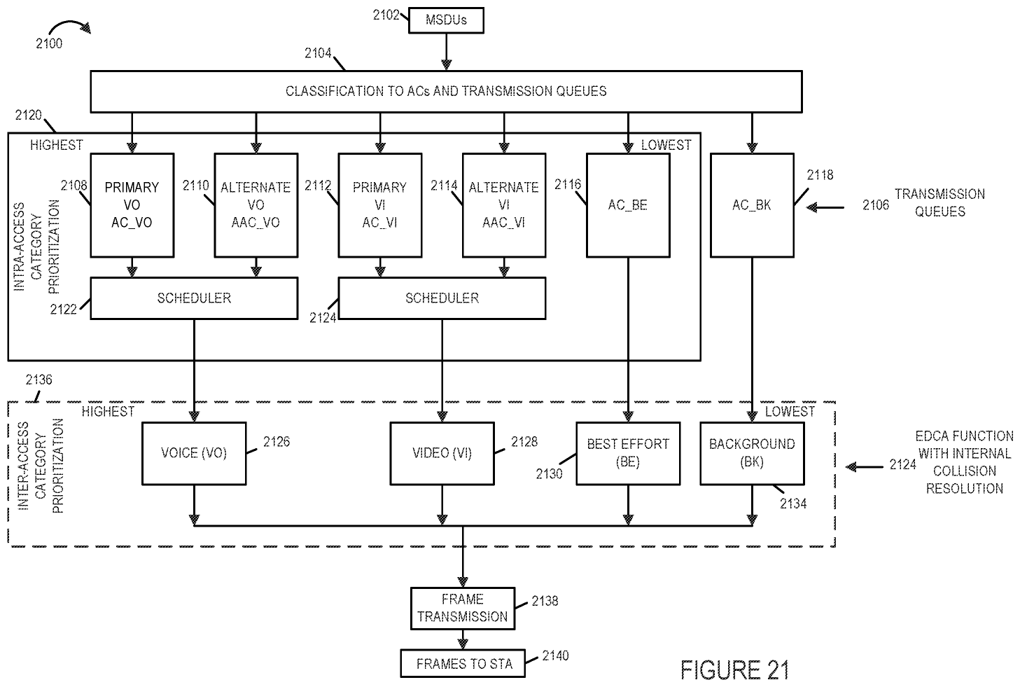

FIG. 21 is drawing 2100 illustrating exemplary components including transmission queues included in an exemplary AP and exemplary operations which are performed in accordance with an exemplary embodiment. Drawing 2100 may represent an exemplary AP, e.g., AP 404 of FIG. 4, in an initial conventional state of operation, e.g., prior to receiving SCS w/L4 Request frame 426 in step 428 of signaling diagram 400 of FIG. 4 or AP 804 of FIG. 8, in an initial conventional state of operation, e.g., prior to receiving MSCS w/L4S Request frame 826 in step 828 of signaling diagram 800 of FIG. 8.

Module 2104 receives MSDUs 2102 and performs classification to access category (AC) and transmission queues. Thus, each received MSDU is processed, e.g., based on information included in the header, and assigned to one of the transmission queues, and sent to the assigned queue, in which it is stored. The set of transmission queues 2106 include: a primary voice (VO) AC_VO transmission queue 2108, an alternate VO AAC_VO transmission queue 2110, a primary video (VI) AC_V1 transmission queue 2112, an alternate VI AAC_VI transmission queue 2114, a Best Effort AC_BE transmission queue 2116, and a Background AC_BK transmission queue 2118. In terms of inter-access category prioritization 2120, the priority order of the queues from highest to lowest is (2108, 2110, 2112, 2114, 2116). The output of the two voice queues (2108, 2110) is fed into scheduler 2122, e.g. an 802.11 scheduler. The output of the two video queues (2112, 2114) is fed into scheduler 2124, an 802.11 scheduler.

Set 2124 of Enhanced Distributed Channel Access (EDCA) functions with collision resolution includes voice (VO) EDCA function 2126, video (VI) EDCA function 2128, best effort (BE) EDCA function 2130 and background (BK) EDCA function 2134. In terms of intra-access category prioritization 2136, the priority order of the EDCA functions from highest to lowest is (2126, 2128, 2130, 2134).

The output from scheduler 2122 is fed as input to Voice (VO) EDCA function 2126, which outputs frames to frame transmission module 2138. The output from scheduler 2124 is fed as input to Video (VI) EDCA function 2128, which outputs frames to frame transmission module 2138. The output of Best Effort AC_BE transmission queue 2116 is fed as input to Best Effort (BE) EDCA function 2126, which outputs frames to frame transmission module 2138. The output of Best Effort AC_BE transmission queue 2116 is fed as input to Best Effort (BE) EDCA function 2126, which outputs frames to frame transmission module 2138. The output of Background AC_BK transmission queue 2118 is fed as input to Background (BK) EDCA function 2134, which outputs frames to frame transmission module 2138. Frame transmission module 2138 transmits received frames, as frames 2140, which are sent to STAs.

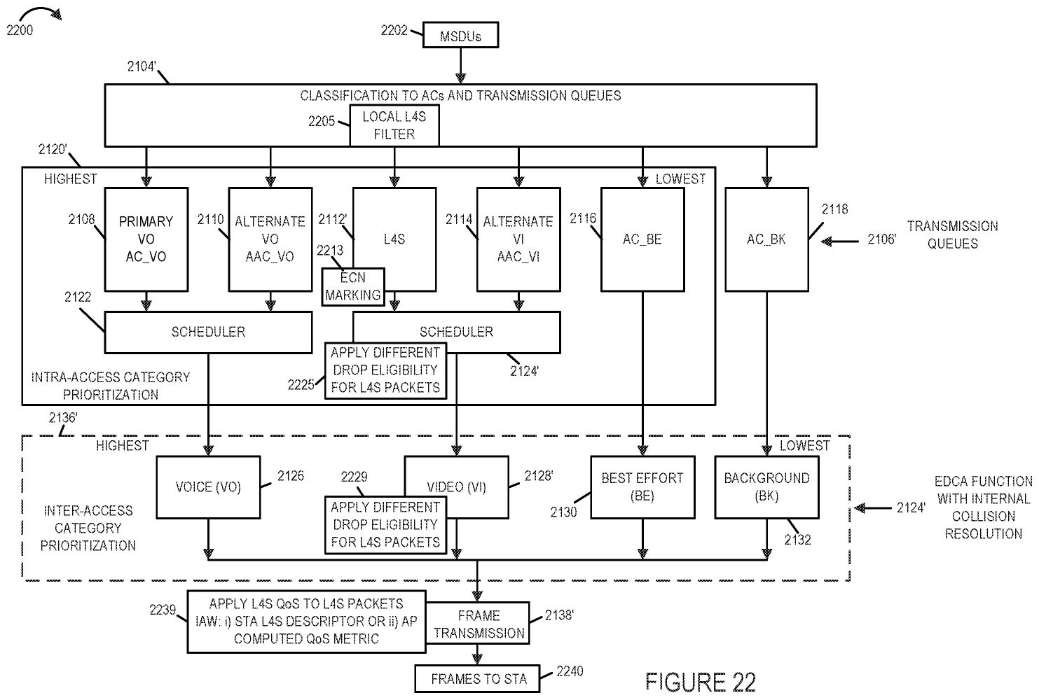

FIG. 22 is drawing 2200 illustrating exemplary components including transmission queues included in an exemplary AP and exemplary operations which are performed in accordance with an exemplary embodiment. Drawing 2200 may represent the exemplary AP of FIG. 21, after: i) receiving and accepting a SCS w/L4S Request frame or a MSCS w/L4S Request frame, ii) selecting a transmission queue for L4S, and iii) creating a L4S filter. Similar elements in FIG. 22 which have modification with regard to FIG. 21 are indicated with a ‘. For example, primary V1 AC_VO transmission queue 2112 in FIG. 21 has been repurposed to be used as the L4S transmission queue and is labeled as 2112’ in FIG. 22. In the example of FIG. 22 MSDUs 2202 are received, classified, and processed by the AP, resulting in frames 2240 directed to STA, said frames 2240 including DL traffic frames conveying L4S data packets and DL traffic frames conveying non-L4S data packets (regular data) to the STA. The received MSDUs which are identified (classified based on the local L4S filter 2205 criteria) as L4S MSDUs are handled differently, e.g., being given preferential treatment in accordance with the exemplary embodiment, and include ECN markings, performed based on the status of the L4S buffer 2212′.

Local L4S filter 2205, which was created by the AP, in response to an AP accepted: received SCS w/L4S Request frame or a received MSCS w/L4S Request frame, is used by classification to ACs and transmission queues module 2104′, directs MSDUs, which have been identified as conveying L4S data, to L4S transmission queue 2112′ (which replaced primary V1 AAC_V1) queue 2112. Based on the status of L4S transmission queue 2112′, with regard to an ECN congestion threshold value received in the L4S descriptor of the received request, ECN marking 2213 is performed, e.g., setting the ECN bits (ECT, CE)=bit pattern 11 to indicate a congestion detected codepoint, when congestion is detected. Different drop eligibility for L4S packets is used, as indicated in information blocks 2225, 2229, e.g. in accordance with created L4S filter, e.g., as compared to regular non-L4S traffic data packets, with the L4S packets getting preferential treatment.

During frame transmission 2138′ L4S QOS is applied (2239) to the L4S packets, e.g., in accordance with (IAW): i) STA L4S description QoS criteria (latency target, desired bandwidth, loss tolerance) or ii) an AP computed QoS metric to be used for L4S traffic, e.g., based on monitored traffic at the AP.

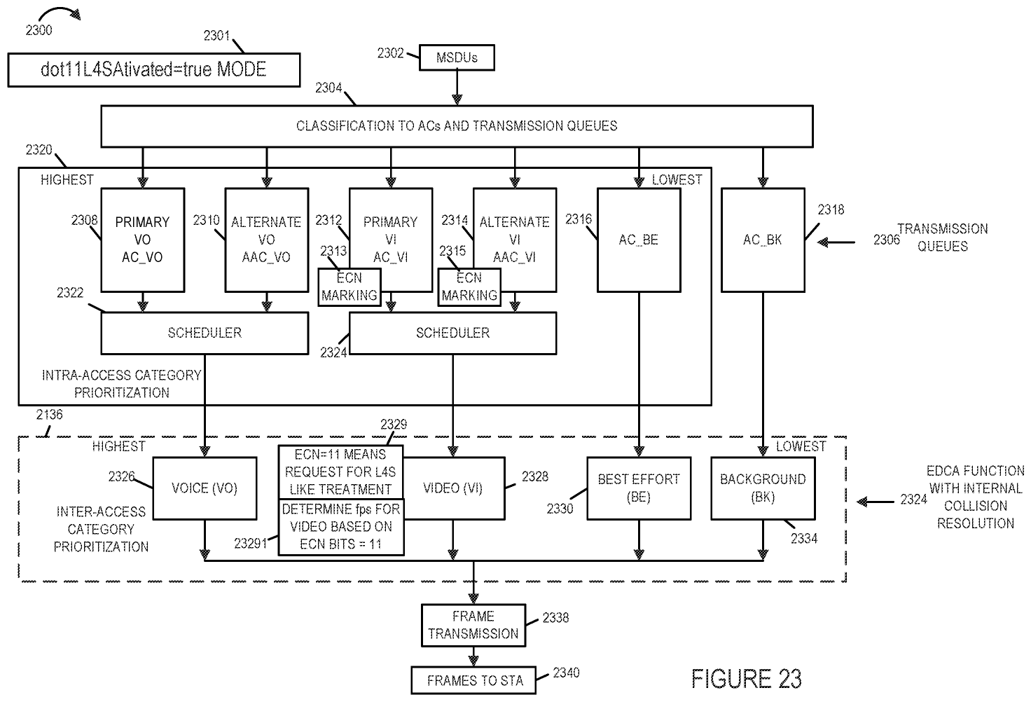

FIG. 23 is drawing 2300 illustrating exemplary components including transmission queues included in an exemplary AP and exemplary operations which are performed in accordance with an exemplary embodiment. Drawing 2300 may represent an exemplary AP, e.g., an AP implementing steps of the method of flowchart 2000 of FIG. 20. Consider that the exemplary AP, has already received and processed an SCS Request frame SCS including a SCS descriptor element, said SCS descriptor element including a traffic classification (TCLAS) element, said TCLAS element including a frame classifier, said frame classifier including a classifier type field and a classifier parameters field, said classifier type field=11 indicating that the classifier parameter field will include additional qualifiers which may be used to determine QoS information, e.g. how many frames per second (fps) for video flow is required, said classifier parameters field including the parameter ECN{11}, and that the access point has been activated in dot11L4SActivated=true mode, as indicated by information block 2301, and is operating to interpret the pattern of ECT=1 and CE=1 in combination in IP header's ECN field as a request for L4S like treatment.

Module 2304 receives MSDUs 2302 and performs classification to access category (AC) and transmission queues. Thus, each received MSDU is processed, e.g., based on information included in the header, and assigned to one of the transmission queues, and sent to the assigned queue, in which it is stored. The set of transmission queues 2306 include: a primary voice (VO) AC_VO transmission queue 2308, an alternate VO AAC_VO transmission queue 2310, a primary video (VI) AC_V1 transmission queue 2112, an alternate VI AAC_VI transmission queue 2314, a Best Effort AC_BE transmission queue 2316, and a Background AC_BK transmission queue 2318. In terms of inter-access category prioritization 2320, the priority order of the queues from highest to lowest is (2308, 2310, 2312, 2314, 2316). The output of the two voice queues (2308, 2310) is fed into scheduler 2322, e.g. an 802.11 scheduler. The output of the two video queues (2312, 2314) is fed into scheduler 2324, an 802.11 scheduler.

Set 2324 of Enhanced Distributed Channel Access (EDCA) functions with collision resolution includes voice (VO) EDCA function 2326, video (VI) EDCA function 2328, best effort (BE) EDCA function 2330 and background (BK) EDCA function 2334. In terms of intra-access category prioritization 2336, the priority order of the EDCA functions from highest to lowest is (2326, 2328, 2330, 2334).

The output from scheduler 2322 is fed as input to Voice (VO) EDCA function 2326, which outputs frames to frame transmission module 2338. The output from scheduler 2324 is fed as input to Video (VI) EDCA function 2328, which outputs frames to frame transmission module 2138. The output of Best Effort AC_BE transmission queue 2316 is fed as input to Best Effort (BE) EDCA function 2326, which outputs frames to frame transmission module 2338. The output of Best Effort AC_BE transmission queue 2316 is fed as input to Best Effort (BE) EDCA function 2326, which outputs frames to frame transmission module 2338. The output of Background AC_BK transmission queue 2318 is fed as input to Background (BK) EDCA function 2334, which outputs frames to frame transmission module 2338. Frame transmission module 2338 transmits received frames, as frames 2340, which are sent to STAs.

Typically received MSDUs 2304 carrying L4S data would be routed to video transmission queues and/or voice transmission queues. In this example, the MSDUs carrying L4S data are classified by module 2304 as being routed to primary and alternate video transmission queues 2312, 2314. Congestion is evaluated at each of the queues (2312, 2314) and ECN markings are performed (2313, 2314) for each respective queue (2312, 1314), e.g., setting the ECN bits in an IP header of a MSDU to indicate the congestion detected codepoint ECN (ECT, CE)=bit pattern 11, when congestion is detected.

The AP, which is operating in dot11L4SActivated=true mode, interprets ECN=11 as meaning request for L4S like treatment, as indicated by information block 2329. Upon detecting the bit pattern 11 in the ECN header field of the IP header of data (MDSU) to be transmitted to a STA, the AP determines (in step 23291) to transmit the data using a frame per second (fps) transmission rate which satisfies L4S criteria, and frame transmission module 2338 transmits frame(s) to the STA at the fps bit rate which satisfies the L4S criteria.

### First List of Numbered Exemplary Method Embodiments

Method Embodiment 1. A method of operating an access point (AP) (e.g., a WiFi AP), the method comprising: receiving (428) at an access point (404) (e.g., at an MLME (410) of an access point) a Stream Classification Service with Low Latency, Low Loss, and Scalable Throughput (SCS w/L4S) request frame (426) from a first station (STA) (402), the SCS w/L4S request frame including an L4S descriptor element (628′) that includes L4S descriptor information (e.g. an element ID 630, a L4S classifier mask (632) which includes information (e.g., source IP and port #corresponding to a L4S stream) used to identify data, e.g. IP packets, belonging to L4S flows, an intra-AC queue designation 634 which designates which intra-AC transmission queue is to be used for L4S data, an ECN threshold 636 used to determine if the L4S data buffer (queue) is congested with regard to setting the CE codepoint, a latency target for L4S data, a desired BW for L4S data, a loss tolerance for L4S data), said SCS w/L4S request frame requesting that the access point create an L4S classifier filter used to identify Media Access Control (MAC) Service Data Units (MSDUs) directed to the first STA which are to be treated as L4S data and given transmission priority over regular (non-L4S) data and designate a transmission queue (buffer) as an L4S buffer; operating the access point (404) (e.g., the MLME (410) in the access point) to create (4411) an L4S classifier filter corresponding to the first STA (402) said L4S classifier filter distinguishing between MSDUs which communicate L4S data and MSDUs which communicate non L4S data; operating the access point (404) to use (710) the classifier filter to determine (e.g., based on comparing information to in the MSDU header to L4S classifier mask information) if an MSDU directed to the first station (402) communicates L4S data (e.g., low latency high priority data) or communicates non-L4S data (e.g., regular priority data); and storing (714) the MSDU in a transmission queue corresponding to the type of data being communicated by the MSDU (e.g., in a L4S high priority data queue or a standard priority data queue).

Method Embodiment 1A. The method of Method Embodiment 1, further comprising: operating the access point (404) to select (4406) a transmission queue for future L4S traffic (L4S data buffer).

Method Embodiment 1A1. The method of Method Embodiment 1, wherein said selected transmission queue for future L4S traffic is determined from the intra-AC (intra Access Category) queue designation communicated in the received L4S descriptor element.

Method Embodiment 1B. The method of Method Embodiment 1A, wherein said selected transmission queue for future L4S traffic replaces a currently assigned transmission queue, said currently assigned transmission queue being designated as one of: i) a primary voice queue, ii) an alternate voice queue, a primary video queue or iv) an alternate video queue.

Method Embodiment 2. The method of Method Embodiment 1, further comprising: communicating (120), from the AP (404) to the first STA (402), an SCS w/L4S response frame (456), said SCS w/L4S response frame (456) indicating creation of the L4S classifier filter requested by the first STA (402).

Method Embodiment 2A. The method of Method Embodiment 1, wherein the L4S descriptor element (628′) includes an element ID (630) identifying the L4S descriptor element (628′) and L4S data classification information (634) (e.g., L4S classifier mask) (e.g., including a list of source IP addresses and corresponding port #s corresponding to sources of L4S data streams expected to be sending L4S data to the first STA).

Method Embodiment 2B. The method of Method Embodiment 2, wherein the L4S descriptor element (628′) further includes an ECN threshold (636).

Method Embodiment 2C. The method of Method Embodiment 2B, wherein the L4S descriptor element (628′) further includes one at least one (e.g., one more or all) of i) a latency target (638), ii) a desired level of bandwidth (640), or iii) a loss tolerance indicator (642).

Method Embodiment 3. The method of Method Embodiment 2, further comprising: operating (472) the AP (404) to decide to terminate the granted L4S classifier filter request; and operating (484) the AP (404) to communicate an SCS w/L4S response frame (486) to the first STA (402) indicating that the grant of the L4S classifier filter request has been terminated.

Method Embodiment 4. The method of Method Embodiment 1, wherein operating the access point (404) to use (710) the classifier filter to determine if an MSDU directed to the first station (402) communicates L4S data (e.g., low latency high priority data) or communicates non-L4S data (e.g., regular priority data) determines that (711) the MSDU is L4S data; and wherein storing (712) the MSDU in a transmission queue corresponding to the type of data being communicated by the MSDU includes storing (712) the MSDU in a L4S data buffer.

Method Embodiment 5. The method of Method Embodiment 4, further comprising: checking (718) if the amount of data in the L4S data buffer exceeds a congestion buffer threshold.

Method Embodiment 5A. The method of Method Embodiment 5, wherein said congestion buffer threshold is the ECN threshold communicated in the received L4S descriptor element.

Method Embodiment 6. The method of Method Embodiment 5, further comprising: in response to determining that the amount of data in the L4S data buffer exceeds the congestion buffer threshold (as indicated by Y 719), setting (720) a congestion experienced (CE) codepoint (ECN=11) in the MSDU prior to communicating the MSDU to the first station.

Method Embodiment 6A The method of Method Embodiment 5, further comprising: in response to determining that the amount of data in the L4S data buffer does not exceed the congestion buffer threshold (as indicated by N 7191), leaving (721) the ECN bits (ECT, CE) in the MSDU unchanged (e.g., leave the ECN bit pattern with whatever pattern it was set to when received (make no change)).

Method Embodiment 7. The method of Method Embodiment 6, further comprising: transmitting (724) the MSDU in accordance with a higher priority than is accorded to non-L4S data, said transmitted MSDU including the ECN bits (ECT, CE) set to the congestion experienced codepoint pattern (11), indicating that congestion was experienced.

Method Embodiment 7A. The method of Method Embodiment 7, wherein transmitting the MSDU in accordance with the higher priority than is accorded to the non-L4S data includes transmitting the MSDU as L4S data in accordance with the latency target, desired bandwidth and loss tolerance information specified in the received L4S descriptor elements.

### First List of Numbered Exemplary Apparatus Embodiments

Apparatus Embodiment 1. An access point (AP) (e.g., a WiFi AP) (404 or 1200) comprising: a wireless receiver (1218); a storage device (e.g., memory (1210) (e.g., including transmission queues (2108, 2110, 2112/2112′, 2114, 2116, 2118)); and a processor (1202) configured to: operate the access point to receive (428) (via the wireless receiver (1218)) at the access point (404) (e.g., at an MLME (410) of an access point) a Stream Classification Service with Low Latency, Low Loss, and Scalable Throughput (SCS w/L4S) request frame (426) from a first station (STA) (402), the SCS w/L4S request frame including an L4S descriptor element (628′) that includes L4S descriptor information (e.g. an element ID 630, a L4S classifier mask (632) which includes information (e.g., source IP and port #corresponding to a L4S stream) used to identify data, e.g. IP packets, belonging to L4S flows, an intra-AC queue designation 634 which designates which intra-AC transmission queue is to be used for L4S data, an ECN threshold 636 used to determine if the L4S data buffer (queue) is congested with regard to setting the CE codepoint, a latency target for L4S data, a desired BW for L4S data, a loss tolerance for L4S data), said SCS w/L4S request frame requesting that the access point create an L4S classifier filter used to identify Media Access Control (MAC) Service Data Units (MSDUs) directed to the first STA which are to be treated as L4S data and given transmission priority over regular (non-L4S) data and designate a transmission queue (buffer) as an L4S buffer; operate the access point (404) (e.g., the MLME (410) in the access point) to create (4411) an L4S classifier filter corresponding to the first STA (402) said L4S classifier filter distinguishing between MSDUs which communicate L4S data and MSDUs which communicate non L4S data; operate the access point (404) to use (710) the classifier filter to determine (e.g., based on comparing information in the MSDU header to L4S classifier mask information) if an MSDU directed to the first station (402) communicates L4S data (e.g., low latency high priority data) or communicates non-L4S data (e.g., regular priority data); and operate the access point (404) to store (714) the MSDU in a transmission queue corresponding to the type of data being communicated by the MSDU (e.g., in a L4S high priority data queue or a standard priority data queue).

Apparatus Embodiment 1A. The access point (404) of Apparatus Embodiment 1, wherein said processor (1202) is further configured to: operate the access point (404) to select (4406) a transmission queue for future L4S traffic (L4S data buffer).

Apparatus Embodiment 1A1. The access point (404) of Apparatus Embodiment 1, wherein said selected transmission queue for future L4S traffic is determined from the intra-AC (intra Access Category) queue designation communicated in the received L4S descriptor element.

Apparatus Embodiment 1B. The access point (404) of Apparatus Embodiment 1A, wherein said selected transmission queue for future L4S traffic replaces a currently assigned transmission queue, said currently assigned transmission queue being designated as one of: i) a primary voice queue, ii) an alternate voice queue, a primary video queue or iv) an alternate video queue.

Apparatus Embodiment 2. The access point (404) of Apparatus Embodiment 1, further comprising: a wireless transmitter (1220); and wherein said processor (1202) is further configured to: operate the access point to communicate (120), from the AP (404) (via the wireless transmitter (1220)) to the first STA (402), an SCS w/L4S response frame (456), said SCS w/L4S response frame (456) indicating creation of the L4S classifier filter requested by the first STA (402).

Apparatus Embodiment 2A. The access point (404) of Apparatus Embodiment 1, wherein the L4S descriptor element (628′) includes an element ID (630) identifying the L4S descriptor element (628′) and L4S data classification information (634) (e.g., L4S classifier mask) (e.g., including a list of source IP addresses and corresponding port #s corresponding to sources of L4S data streams expected to be sending L4S data to the first STA).

Apparatus Embodiment 2B. The access point (404) of Apparatus Embodiment 2, wherein the L4S descriptor element (628′) further includes an ECN threshold (636).

Apparatus Embodiment 2C. The access point (404) of Apparatus Embodiment 2B, wherein the L4S descriptor element (628′) further includes one at least one (e.g., one more or all) of i) a latency target (638), ii) a desired level of bandwidth (640), or iii) a loss tolerance indicator (642).

Apparatus Embodiment 3. The access point (404) of Apparatus Embodiment 2, wherein said processor (1202) is further configured to: operate (472) the AP (404) to decide to terminate the granted L4S classifier filter request; and operate (484) the AP (404) to communicate (via wireless transmitter 1220) an SCS w/L4S response frame (486) to the first STA (402) indicating that the grant of the L4S classifier filter request has been terminated.

Apparatus Embodiment 4. The access point (404) of Apparatus Embodiment 1, wherein said processor (1202) is configured to: operate the access point (404) to determine that (711) the MSDU is L4S data, as part of being configured to operate the access point (404) to use (710) the classifier filter to determine if an MSDU directed to the first station (402) communicates L4S data (e.g., low latency high priority data) or communicates non-L4S data (e.g., regular priority data); and wherein said processor (1202) is configured to operate the access point (404) to store (712) the MSDU in a L4S data buffer, as part of being configured to operate the access point to store (712) the MSDU in a transmission queue corresponding to the type of data being communicated by the MSDU.

Apparatus Embodiment 5. The access point (404) of Apparatus Embodiment 4, wherein said processor (1202) is further configured to: operate the access point (404) to check (718) if the amount of data in the L4S data buffer exceeds a congestion buffer threshold.

Apparatus Embodiment 5A. The access point (404) of Apparatus Embodiment 5, wherein said congestion buffer threshold is the ECN threshold communicated in the received L4S descriptor element.

Apparatus Embodiment 6. The access point (404) of Apparatus Embodiment 5, wherein said processor (1202) is further configured to: in response to determining that the amount of data in the L4S data buffer exceeds the congestion buffer threshold (as indicated by Y 719), operate the access point to set (720) a congestion experienced (CE) codepoint (ECN=11) in the MSDU prior to communicating the MSDU to the first station.

Apparatus Embodiment 6A The access point (404) of Apparatus Embodiment 5, wherein said processor (1202) is further configured to: in response to determining that the amount of data in the L4S data buffer does not exceed the congestion buffer threshold (as indicated by N 7191), operate the access point to leave (721) the ECN bits (ECT, CE) in the MSDU unchanged (e.g., leave the ECN bit pattern with whatever pattern it was set to when received (make no change)).

Apparatus Embodiment 7. The access point (404) of Apparatus Embodiment 6, further comprising: a wireless transmitter (1220); and wherein said processor (1202) is further configured to: operate the access point (404) to transmit (724) (via wireless transmitter (1220)) the MSDU in accordance with a higher priority than is accorded to non-L4S data, said transmitted MSDU including the ECN bits (ECT, CE) set to the congestion experienced codepoint pattern (11), indicating that congestion was experienced.

Apparatus Embodiment 7A. The access point (404) of Apparatus Embodiment 7, wherein said processor (1202) is configured to operate the access point to transmit the MSDU as L4S data in accordance with the latency target, desired bandwidth and loss tolerance information specified in the received L4S descriptor elements, as part of being configured to operate the access point to transmit the MSDU in accordance with the higher priority than is accorded to the non-L4S data.

### Second List of Numbered Exemplary Method Embodiments

Method Embodiment 1. A method of operating a station (STA) (e.g., a WiFi station) (402), the method comprising: determining (414) that a Low Latency, Low Loss, and Scalable Throughput (L4S) filter should be setup at an access point (404); generating (422) a Stream Classification Service (SCS) w/L4S request frame (426), the SCS w/L4S request frame including an L4S descriptor element (628′) that includes L4S descriptor information (e.g. an element ID 630, a L4S classifier mask (632) which includes information (e.g., source IP and port #corresponding to a L4S stream) used to identify data, e.g. IP packets, belonging to L4S flows, an intra-AC queue designation 634 which designates which intra-AC transmission queue is to be used for L4S data, an ECN threshold 636 used to determine if the L4S data buffer (queue) is congested with regard to setting the CE codepoint, a latency target for L4S data, a desired BW for L4S data, a loss tolerance for L4S data), said SCS w/L4S request frame requesting that the access point create an L4S classifier filter used to identify Media Access Control (MAC) Service Data Units (MSDUs) directed to the STA which are to be treated as L4S data and given transmission priority over regular (non-L4S) data and designate a transmission queue (buffer) as an L4S buffer; and transmitting (424) the generated SCS w/L4S request frame to the access point (404) (e.g., to an MLME (410) of an access point).

Method Embodiment 1A. The method of Method Embodiment 1, wherein generating (422) the SCS w/L4S request frame (426) includes: including in the SCS w/L4S request frame (426) an intra-AC queue indicating an AP queue for L4S traffic.

Method Embodiment 1B. The method of Method Embodiment 1A, wherein said selected transmission queue for future L4S traffic is a queue that was previously designated at the access point as one of: i) a primary voice queue, ii) an alternate voice queue, a primary video queue or iv) an alternate video queue.

Method Embodiment 2. The method of Method Embodiment 1, further comprising: receiving (458), from the AP (404), an SCS w/L4S response frame (456), said SCS w/L4S response frame (456) indicating creation of the L4S classifier filter requested by the first STA (402).

Method Embodiment 2A. The method of Method Embodiment 1, wherein generating (422) the SCS w/L4S request frame (426) includes: including in the L4S descriptor element (628′) an element ID (630) and L4S data classification information (634) (e.g., L4S classifier mask) (e.g., including a list of source IP addresses and corresponding port #s corresponding to sources of L4S data streams expected to be sending L4S data to the STA).

Method Embodiment 2B. The method of Method Embodiment 2A, wherein generating (422) the SCS w/L4S request frame (426) further includes: including in the L4S descriptor element (628′) an ECN threshold (636).

Method Embodiment 2C. The method of Method Embodiment 2B, wherein generating (422) the SCS w/L4S request frame (426) further includes:
including in the L4S descriptor element (628′) at least one (e.g., one more or all) of: i) a latency target (638), ii) a desired level of bandwidth (640), or iii) a loss tolerance indicator (642).

Method Embodiment 3. The method of Method Embodiment 2, further comprising: receiving (488) an SCS w/L4S response frame (486) to the first STA (402) indicating that the grant of the L4S classifier filter request has been terminated.

Method Embodiment 4. The method of Method Embodiment 3, further comprising: receiving (4684) from the access point (404) an MSDU with a congestion experienced (CE) codepoint (e.g., MSDU with ECN=11) that was set by the AP in response to the AP determining that the amount of data in the L4S data buffer exceeds the congestion buffer threshold (as indicated by Y 719).

Method Embodiment 4A. The method of Method Embodiment 3, further comprising: receiving (4684) from the access pint (404) an MSDU with a congestion experienced (CE) codepoint that was left unchanged by the access point following the access point determining that the amount of data in the L4S data buffer did not exceed the congestion buffer threshold (as indicated by N 7191), (e.g., the AP left the ECN bit pattern (ECT and CE bit values) with whatever pattern they were set to when received by the access point (e.g., the access point made no change to the ECN values of the received MSDU)).

### Second List of Numbered Exemplary Apparatus Embodiments

Apparatus Embodiment 1. A station (STA) (e.g., a WiFi station) (402 or 1300) comprising: a wireless transmitter (1326); and a processor (1302) configured to: operate (e.g., control) the station to determine (414) that a Low Latency, Low Loss, and Scalable Throughput (L4S) filter should be setup at an access point (AP) (404); operate the station (402) to generate (422) an SCS w/L4S request frame (426), the SCS w/L4S request frame including an L4S descriptor element (628′) that includes L4S descriptor information (e.g. an element ID 630, a L4S classifier mask (632) which includes information (e.g., source IP and port #corresponding to a L4S stream) used to identify data, e.g. IP packets, belonging to L4S flows, an intra-AC queue designation 634 which designates which intra-AC transmission queue is to be used for L4S data, an ECN threshold 636 used to determine if the L4S data buffer (queue) is congested with regard to setting the CE codepoint, a latency target for L4S data, a desired BW for L4S data, a loss tolerance for L4S data), said SCS w/L4S request frame requesting that the access point create an L4S classifier filter used to identify Media Access Control (MAC) Service Data Units (MSDUs) directed to the STA which are to be treated as L4S data and given transmission priority over regular (non-L4S) data and designate a transmission queue (buffer) as an L4S buffer; and operate the station (402) to transmit (424) (e.g., via the wireless transmitter 1326) the generated SCS w/L4S request frame to the access point (404) (e.g., to an MLME (410) of an access point).

Apparatus Embodiment 1A. The station (402) of Apparatus Embodiment 1, wherein said processor (1302) is configured to: operate the station (402) to include in the SCS w/L4S request frame (426) an intra-AC (intra Access Category) queue indicating an AP queue for L4S traffic, as part of being configured to operate the station to generate (422) the SCS w/L4S request frame (426).

Apparatus Embodiment 1B. The station (402) of Apparatus Embodiment 1A, wherein said selected transmission queue for future L4S traffic is a queue that was previously designated at the access point as one of: i) a primary voice queue, ii) an alternate voice queue, a primary video queue or iv) an alternate video queue.

Apparatus Embodiment 2. The station (402) of Apparatus Embodiment 1, further comprising: a wireless receiver (1324); and wherein said processor (1302) is further configured to: operate the station (402) to receive (458), from the AP (404), an SCS w/L4S response frame (456), said SCS w/L4S response frame (456) indicating creation of the L4S classifier filter requested by the STA (402).

Apparatus Embodiment 2A. The station (402) of Apparatus Embodiment 1, wherein said processor (1302) is configured to: operate the station (402) to include in the L4S descriptor element (628′) an element ID (630) and L4S data classification information (634) (e.g., L4S classifier mask) (e.g., including a list of source IP addresses and corresponding port #s corresponding to sources of L4S data streams expected to be sending L4S data to the STA), as part of being configured to operate the station to generate (422) the SCS w/L4S request frame (426).

Apparatus Embodiment 2B. The station (402) of Apparatus Embodiment 2A, wherein said processor (1302) is configured to operate the station (402) to include in the L4S descriptor element (628′) an ECN threshold (636), as part of being configured to operate the station to generate (422) the SCS w/L4S request frame (426).

Apparatus Embodiment 2C. The station (402) of Apparatus Embodiment 2B, wherein said processor (1302) is configured to operate the station to include in the L4S descriptor element (628′) at least one (e.g., one more or all) of: i) a latency target (638), ii) a desired level of bandwidth (640), or iii) a loss tolerance indicator (642), as part of being configured to operate the station to generate (422) the SCS w/L4S request frame (426).

Apparatus Embodiment 3. The station (402) of Apparatus Embodiment 2, wherein said processor (1302) is further configured to: operate the station (402) to receive (488) (via wireless receiver 1324) an SCS w/L4S response frame (486) to the first STA (402) indicating that the grant of the L4S classifier filter request has been terminated.

Apparatus Embodiment 4. The station (402) of Apparatus Embodiment 3, wherein said processor (1302) is further configured to: operate the station (402) to receive (4684) (via wireless receiver 1324) from the access pint (404) an MSDU with a congestion experienced (CE) codepoint (e.g., MSDU with ECN=11) that was set by the AP in response to the AP determining that the amount of data in the L4S data buffer exceeds the congestion buffer threshold (as indicated by Y 719).

Apparatus Embodiment 4A. The station (402) of Apparatus Embodiment 3, wherein said processor (1302) is further configured to: operate the station (402) to receive (4684) (via the wireless receiver 1324) from the access point (404) an MSDU with a congestion experienced (CE) codepoint that was left unchanged by the access point following the access point determining that the amount of data in the L4S data buffer did not exceed the congestion buffer threshold (as indicated by N 7191), (e.g., the AP left the ECN bit pattern (ECT and CE bit values) with whatever pattern they were set to when received by the access point (e.g., the access point made no change to the ECN values of the received MSDU)).

### Third List of Numbered Exemplary Method Embodiments

Method Embodiment 1. A method of operating an access point (AP) (e.g., a WiFi AP) (804 or 1200), the method comprising: receiving (826) at the access point (804) (e.g., at an MLME (810) of an access point) a Mirrored Stream Classification Service with Low Latency, Low Loss, and Scalable Throughput (MSCS w/L4S) request frame (826) (which may be the frame 1002 of FIG. 10) from a first station (STA) (802), the MSCS w/L4S request frame (826 or 1002) including an L4S descriptor element (1028 or 1028′) that includes an element ID (1030) and an Explicit Congestion Notification (ECN) threshold (1036) (e.g., a threshold used to determine if the L4S buffer in the AP is congested); operating the access point (804) (e.g., the MLME (810) in the access point) to create (8411) an L4S classifier filter corresponding to the first STA (802), said L4S classifier filter distinguishing between Media Access Control (MAC) Service Data Units (MSDUs) which communicate L4S data and MSDUs which communicate non L4S data; operating the access point (804) to use the L4S classifier filter to determine (1110 see FIG. 11) if an MSDU directed to the first station (402) communicates data to be treated as L4S data (e.g., low latency high priority data) or communicates non-L4S data (e.g., regular priority data); and storing (1114) the MSDU in a transmission queue corresponding to the type of data being communicated by the MSDU (e.g., in a L4S high priority data queue or a standard priority data queue).

Method Embodiment 1A. The method of Method Embodiment 1, wherein said L4S descriptor element (1028 or 1028′) further includes: a L4S Classifier Mask (1032) (classification parameter types (e.g. source IP, port) but, in some cases, not specific values, to be used to identify data, e.g., IP packets, belonging to L4S flows (via traffic monitoring and identifying streams suspected to be carrying L4S traffic)).

Method Embodiment 1B. The method of Method Embodiment 1, further comprising: operating the access point (804) to select (8406) a transmission queue for future L4S traffic (L4S data buffer).

Method Embodiment 1C. The method of Method Embodiment 1B, wherein said selected transmission queue for future L4S traffic replaces a currently assigned transmission queue, said currently assigned transmission queue being designated as one of: i) a primary voice queue, ii) an alternate voice queue, a primary video queue or iv) an alternate video queue.

Method Embodiment 2. The method of Method Embodiment 1, further comprising: communicating (854), from the AP (804) to the first STA (802), an MSCS w/L4S response frame (856), said MSCS w/L4S response frame (856) indicating creation of an L4S classifier filter.

Method Embodiment 2A. The method of Method Embodiment 1, wherein the L4S descriptor element (1028′) includes an element ID (1030) identifying the L4S descriptor element (1028′) and said ECN threshold (2036) used to determined if the L4S buffer is congested.

Method Embodiment 2B. The method of Method Embodiment 2A, wherein the L4S descriptor element (108′) further includes at least one (e.g., one, more than one, or all) of i) a L4S classifier mask (1032), ii) a latency target (1038), ii) a desired level of bandwidth (1040), or iii) a loss tolerance indicator (1042).

Method Embodiment 3. The method of Method Embodiment 2, further comprising: operating (882) the AP (804) to decide to terminate the granted L4S classifier filter request; and operating (884) the AP (804) to communicate an MSCS w/L4S response frame (886) to the first STA (802) indicating that the grant of the L4S classifier filter request has been terminated.

Method Embodiment 4. The method of Method Embodiment 1, wherein operating the access point (804) to use (1110) the classifier filter to determine if an MSDU directed to the first station (802) communicates L4S data (e.g., low latency high priority data) or communicates non-L4S data (e.g., regular priority data) determines (1111) that the MSDU is L4S data; and wherein storing (1112) the MSDU in a transmission queue corresponding to the type of data being communicated by the MSDU includes storing (1114) the MSDU in a L4S data buffer.

Method Embodiment 5. The method of Method Embodiment 4, further comprising: checking (1118) if the amount of data in the L4S data buffer exceeds a congestion buffer threshold.

Method Embodiment 6. The method of Method Embodiment 5, further comprising: in response to determining that the amount of data in the L4S data buffer exceeds the congestion buffer threshold (as indicated by Y 1119), setting (1120) a congestion experienced (CE) codepoint (ECN=11) in the MSDU prior to communicating the MSDU to the first station.

Method Embodiment 6A The method of Method Embodiment 5, further comprising: in response to determining that the amount of data in the L4S data buffer does not exceed the congestion buffer threshold (as indicated by N 11191), leaving (1121) the ECN bits in the MSDU unchanged (e.g., leave the ECN bits (ECT, CE) with whatever bit pattern it was set to when received (make no change)).

Method Embodiment 7. The method of Method Embodiment 6, further comprising: transmitting (1124) the MSDU in accordance with a higher priority than is accorded with non-L4S data, said transmitted MSDU including the ECN bits set to a pattern (11) indicating that congestion was experienced.

Method Embodiment 8. The method of Method Embodiment 7, further comprising: determining (1117) a required QoS for the MSDU conveying L4S data, said determined required QoS being a computed QoS metric.

Method Embodiment 8A. The method of Method Embodiment 8, wherein said received L4S descriptor element further includes one or more of: a latency target (1038), a desired bandwidth (1040), or a loss tolerance (1042), and wherein determining (1117) a required QoS for the MSDU conveying L4S data includes using one or more of: the latency target (1038), the desired bandwidth (1040), the loss tolerance (1042) in determining the computed QoS metric.

Method Embodiment 9. The method of Method Embodiment 8, wherein transmitting (1124) the MSDU in accordance with a higher priority than priority than is accorded with the non-L4S data includes transmitting the MSDU as L4S data in accordance with the computed QoS metric.

Method Embodiment 10. The method of Method Embodiment 1, wherein creating (8411) a L4S filter includes: monitoring uplink traffic streams; detecting uplink traffic streams having parameters relating to L4S traffic; designating downlink traffic streams corresponding to the detected uplink traffic streams as downlink L4S traffic streams; obtaining stream ID information corresponding to the downlink L4S traffic streams; and using the obtained stream ID information in the L4S classifier filter to identify L4S MSDUs (e.g., via stream ID comparisons and matching).

### Third List of Numbered Exemplary Apparatus Embodiments

Apparatus Embodiment 1. An access point (AP) (e.g., a WiFi AP) (804 or 1200) comprising: a wireless receiver (1218); a storage device (e.g., memory 1210) (e.g., including transmission queues (2108, 2110, 2112/2112′, 2114, 2116, 2118)); and a processor (1202) configured to: operate (e.g., control) the access point (804) to receive (826) (via wireless receiver (1218)) at the access point (804) (e.g., at an MLME (810) of an access point) a Mirrored Stream Classification Service with Low Latency, Low Loss, and Scalable Throughput (MSCS w/L4S) request frame (826) (which may be the frame 1002 of FIG. 10) from a first station (STA) (802), the MSCS w/L4S request frame (826 or 1002) including an L4S descriptor element (1028 or 1028′) that includes an element ID (1030) and an ECN threshold (1036) (e.g., a threshold used to determine if the L4S buffer in the AP is congested); operate the access point (804) (e.g., the MLME (810) in the access point) to create (8411) an L4S classifier filter corresponding to the first STA (802), said L4S classifier filter distinguishing between Media Access Control (MAC) Service Data Units (MSDUs) which communicate L4S data and MSDUs which communicate non L4S data; operate the access point (804) to use the classifier filter to determine (1110 see FIG. 11) if an MSDU directed to the first station (402) communicates data to be treated as L4S data (e.g., low latency high priority data) or communicates non-L4S data (e.g., regular priority data); and operate the access point (804) to store (1114) the MSDU in a transmission queue corresponding to the type of data being communicated by the MSDU (e.g., in a L4S high priority data queue or a standard priority data queue).

Apparatus Embodiment 1A. The access point (804) of Apparatus Embodiment 1, wherein said L4S descriptor element (1028 or 1028′) further includes: a L4S Classifier Mask (1032) (classification parameter types (e.g. source IP, port) but, in some cases, not specific values, to be used to identify data, e.g., IP packets, belonging to L4S flows (via traffic monitoring and identifying streams suspected to be carrying L4S traffic)).

Apparatus Embodiment 1B. The access point (804) of Apparatus Embodiment 1, wherein said processor (1202) is further configured to: operate the access point (804) to select (8406) a transmission queue for future L4S traffic (L4S data buffer).

Apparatus Embodiment 1C. The access point (804) of Apparatus Embodiment 1B, wherein said selected transmission queue for future L4S traffic replaces a currently assigned transmission queue, said currently assigned transmission queue being designated as one of: i) a primary voice queue, ii) an alternate voice queue, a primary video queue or iv) an alternate video queue.

Apparatus Embodiment 2. The access point (804) of Apparatus Embodiment 1, further comprising: a wireless transmitter (1220); and wherein said processor (1202) is further configured to: operate the access point (804) to communicate (854) (e.g., via wireless transmitter 1220), from the AP (804) to the first STA (802), an MSCS w/L4S response frame (856), said MSCS w/L4S response frame (856) indicating creation of an L4S classifier filter.

Apparatus Embodiment 2A. The access point (804) of Apparatus Embodiment 1, wherein the L4S descriptor element (1028′) includes an element ID (1030) identifying the L4S descriptor element (1028′) and said ECN threshold (2036) used to determine if the L4S buffer is congested.

Apparatus Embodiment 2B. The access point (804) of Apparatus Embodiment 2A, wherein the L4S descriptor element (108′) further includes at least one (e.g., one, more than one, or all) of i) a L4S classifier mask (1032), ii) a latency target (1038), ii) a desired level of bandwidth (1040), or iii) a loss tolerance indicator (1042).

Apparatus Embodiment 3. The access point (804) of Apparatus Embodiment 2, wherein said processor (1202) is further configured to: operate (882) the AP (804) to decide to terminate the granted L4S classifier filter request; and operate (884) the AP (804) to communicate (via wireless transmitter 1220) an MSCS w/L4S response frame (886) to the first STA (802) indicating that the grant of the L4S classifier filter request has been terminated.

Apparatus Embodiment 4. The access point (804) of Apparatus Embodiment 1, wherein said processor (1202) is configured to: operate the access point (804) to determine (1111) that the MSDU is L4S data, as part of being configured to operate the access point (804) to use (1110) the classifier filter to determine if an MSDU directed to the first station (802) communicates L4S data (e.g., low latency high priority data) or communicates non-L4S data (e.g., regular priority data); and operate the access point (804) to store (1114) the MSDU in a L4S data buffer, as part of being configured to operate the access point (804) to store (1112) the MSDU in a transmission queue corresponding to the type of data being communicated by the MSDU.

Apparatus Embodiment 5. The access point (804) of Apparatus Embodiment 4, wherein said processor (1202) is further configured to: operate the access point (804) to check (1118) if the amount of data in the L4S data buffer exceeds a congestion buffer threshold.

Apparatus Embodiment 6. The access point (804) of Apparatus Embodiment 5, wherein said processor (1202) is further configured to: in response to determining that the amount of data in the L4S data buffer exceeds the congestion buffer threshold (as indicated by Y 1119), operate the access point (804) to set (1120) a congestion experienced (CE) codepoint (ECN=11) in the MSDU prior to communicating the MSDU to the first station.

Apparatus Embodiment 6A The access point (804) of Apparatus Embodiment 5, wherein said processor (1202) is further configured to: in response to determining that the amount of data in the L4S data buffer does not exceed the congestion buffer threshold (as indicated by N 11191), operate the access point (804) to leave (1121) the ECN bits in the MSDU unchanged (e.g., leave the ECN bits (ECT, CE) with whatever bit pattern it was set to when received (make no change)).

Apparatus Embodiment 7. The access point (804) of Apparatus Embodiment 6, further comprising: a wireless transmitter (1220); and wherein said processor (1202) is further configured to: operate the access point (804) to transmit (1124) (via wireless transmitter 1220) the MSDU in accordance with a higher priority than is accorded with non-L4S data, said transmitted MSDU including the ECN bits set to a pattern (11) indicating that congestion was experienced.

Apparatus Embodiment 8. The access point (804) of Apparatus Embodiment 7, wherein said processor (1200) is further configured to: operate the access point (804) to determine (1117) a required Quality of Service (QOS) for the MSDU conveying L4S data, said determined required QoS being a computed Qos metric.

Apparatus Embodiment 8A. The access point (804) of Apparatus Embodiment 8, wherein said received L4S descriptor element further includes one or more of: a latency target (1038), a desired bandwidth (1040), or a loss tolerance (1042), and wherein said processor (1202) is configured to operate the access point to use one or more of: the latency target (1038), the desired bandwidth (1040), the loss tolerance (1042) in determining the computed QoS metric, as part of being configured to operate the access point to determine (1117) a required QoS for the MSDU conveying L4S data.

Apparatus Embodiment 9. The access point (804) of Apparatus Embodiment 8, wherein said processor (1202) is configured to operate the access point to transmit the MSDU as L4S data in accordance with the computed QoS metric, as part of being configured to operate the access point to transmit (1124) the MSDU in accordance with a higher priority than priority than is accorded with the non-L4S data.

Apparatus Embodiment 10. The access point (804) of Apparatus Embodiment 1, wherein said processor (1202) is configured to operate the access point (804) to: monitor uplink traffic streams; detect uplink traffic streams having parameters relating to L4S traffic; designate downlink traffic streams corresponding to the detected uplink traffic streams as downlink L4S traffic streams; obtain stream ID information corresponding to the downlink L4S traffic streams; and use the obtained stream ID information in the L4S classifier filter to identify L4S MSDUs (e.g., via stream ID comparisons and matching), as part of being configured to operate the access point (804) to create (8411) a L4S filter.

### Fourth List of Numbered Exemplary Method Embodiments

Method Embodiment 1. A method of operating a station (STA) (e.g., a WiFi station) (802), the method comprising: determining (814) that a Low Latency, Low Loss, and Scalable Throughput (L4S) filter should be setup at an access point (AP) (804) (e.g., via MSCS framework); generating (822) (e.g., at an MLME (808) of the station 802) a Mirrored Stream Classification Service (MSCS) w/L4S request frame (826) (which may be the frame 1002 of FIG. 10), the MSCS w/L4S request frame (826 or 1002) including an L4S descriptor element (1028 or 1028′) that includes an element ID (1030) and an ECN threshold (1036) (e.g., a threshold used to determine if the L4S buffer in the AP is congested); and transmitting (824) the MSCS w/L4S request frame (826) to an access point (804).

Method Embodiment 1A. The method of Method Embodiment 1, wherein generating (822) the MSCS w/L4S request frame (826) includes including in said L4S descriptor element (1028 or 1028′) a L4S Classifier Mask (1032) (classification parameter types (e.g. source IP, port) but, in some cases, not specific values, to be used to identify data, e.g., IP packets, belonging to L4S flows (via traffic monitoring and identifying streams suspected to be carrying L4S traffic)).

Method Embodiment 2. The method of Method Embodiment 1, further comprising: receiving (858), from the AP (804), an MSCS w/L4S response frame (856), said MSCS w/L4S response frame (856) indicating creation of an L4S classifier filter (e.g., as indicated by acceptance of the request).

Method Embodiment 2A. The method of Method Embodiment 1, wherein the L4S descriptor element (1028 or 1028′) includes an element ID (1030) identifying the L4S descriptor element (1028′) as an L4S descriptor and said ECN threshold (1036).

Method Embodiment 2B. The method of Method Embodiment 2A, wherein generating (822) the MSCS w/L4S request frame (826) includes including in said L4S descriptor element (1028 or 1028′) at least one (e.g., one, more than one, or all) of i) a L4S classifier mask (1032), ii) a latency target (1038), ii) a desired level of bandwidth (1040), or iii) a loss tolerance indicator (1042).

Method Embodiment 3. The method of Method Embodiment 2, further comprising: operating (884) the station (802) to receive an MSCS w/L4S response frame (886) to the STA (802) indicating that the grant of the L4S classifier filter request has been terminated.

Method Embodiment 4. The method of Method Embodiment 3, further comprising: receiving (8684) from the access point (804) an MSDU with a congestion experienced (CE) codepoint (e.g., MSDU with ECN=11) that was set by the AP in response to the AP determining that the amount of data in the L4S data buffer exceeds the congestion buffer threshold (as indicated by Y 1119).

Method Embodiment 4A The method of Method Embodiment 3, further comprising: receiving (8684) from the access point (804) an MSDU with a congestion experienced (CE) codepoint that was left unchanged by the access point (804) following the access point determining that the amount of data in the L4S data buffer did not exceed the congestion buffer threshold (as indicated by N 11191), (e.g., the AP left the ECN bit pattern (ECT and CE bit values) with whatever pattern they were set to when received by the access point (e.g., the access point made no change to the ECN values of the received MSDU)).

### Fourth List of Numbered Exemplary Apparatus Embodiments

Apparatus Embodiment 1. A station (STA) (e.g., a WiFi station) (802 or 1300) comprising: a wireless transmitter (1326); and a processor (1302) configured to: operate (e.g. control) the station (802) to determine (814) that a Low Latency, Low Loss, and Scalable Throughput (L4S) filter should be setup at an access point (AP) (804) (e.g., via MSCS framework); operate the station (802) to generate (822) (e.g., at an MLME (808) of the station 802) an Mirrored Stream Classification Service (MSCS) w/L4S request frame (826) (which may be the frame 1002 of FIG. 10), the MSCS w/L4S request frame (826 or 1002) including an L4S descriptor element (1028 or 1028′) that includes an element ID (1030) and an Explicit Congestion Notification (ECN) threshold (1036) (e.g., a threshold used to determine if the L4S buffer in the AP is congested); and operate the station (802) to transmit (824) (e.g., via wireless transmitter 1326) the MSCS w/L4S request frame (826) to an access point (804).

Apparatus Embodiment 1A. The station (802) of Apparatus Embodiment 1, wherein said processor (1302) is configured to: operate the station (802) to include in said L4S descriptor element (1028 or 1028′) a L4S Classifier Mask (1032) (classification parameter types (e.g. source IP, port) but, in some cases, not specific values, to be used to identify data, e.g., IP packets, belonging to L4S flows (via traffic monitoring and identifying streams suspected to be carrying L4S traffic)), as part of being configured to operate the station (802) to generate (822) the MSCS w/L4S request frame (826).

Apparatus Embodiment 2. The station (802) of Apparatus Embodiment 1, further comprising: a wireless receiver (1324); and wherein said processor (1302) is further configured to operate the station (802) to: receive (858) (via the wireless receiver 1324), from the AP (804), an MSCS w/L4S response frame (856), said MSCS w/L4S response frame (856) indicating creation of an L4S classifier filter (e.g., as indicated by acceptance of the request).

Apparatus Embodiment 2A. The station (802) of Apparatus Embodiment 1, wherein the L4S descriptor element (1028 or 1028′) includes an element ID (1030) identifying the L4S descriptor element (1028′) as an L4S descriptor and said ECN threshold (1036).

Apparatus Embodiment 2B. The station (802) of Apparatus Embodiment 2A, wherein said processor (1302) is configured to: operate the station (802) to include in said L4S descriptor element (1028 or 1028′) at least one (e.g., one, more than one, or all) of i) a L4S classifier mask (1032), ii) a latency target (1038), ii) a desired level of bandwidth (1040), or iii) a loss tolerance indicator (1042), as part of being configured to operate the station to generate (822) the MSCS w/L4S request frame (826).

Apparatus Embodiment 3. The station (802) of Apparatus Embodiment 2, wherein said processor (1302) is further configured to: operate (884) the station (802) to receive (via the wireless receiver (1324)) an MSCS w/L4S response frame (886) to the first STA (802) indicating that the grant of the L4S classifier filter request has been terminated.

Apparatus Embodiment 4. The station (802) of Apparatus Embodiment 3, wherein said processor (1302) is further configured to: operate the station (802) to receive (8684) (e.g., via wireless receiver (1324)) from the access point (804) an MSDU with a congestion experienced (CE) codepoint (e.g., MSDU with ECN=11) that was set by the AP in response to the AP determining that the amount of data in the L4S data buffer exceeds the congestion buffer threshold (as indicated by Y 1119).

Apparatus Embodiment 4A The station (802) of Apparatus Embodiment 3, wherein said processor (1302) is further configured to: operate the station (802) to receive (8684) (e.g., via wireless receiver (1324)) from the access point (804) an MSDU with a congestion experienced (CE) codepoint that was left unchanged by the access point (804) following the access point determining that the amount of data in the L4S data buffer did not exceed the congestion buffer threshold (as indicated by N 11191), (e.g., the AP left the ECN bit pattern (ECT and CE bit values) with whatever pattern they were set to when received by the access point (e.g., the access point made no change to the ECN values of the received MSDU)).

### Fifth List of Numbered Exemplary Method Embodiments

Method Embodiment 1. A method of operating an access point (AP) (302 or 1200), comprising: receiving (2014) an Stream Classification Service (SCS) Request frame (1900) from a station (320), said SCS Request frame (1900) including an SCS descriptor element (1500 or 1902) including a classifier type field (1706 or 1908) set to an integer value in the range of 11-255, said value indicating that a corresponding classifier parameters field (1708 or 1910) included in SCS descriptor element (1500 or 1902) will include one or more qualifiers indicating how the AP is to treat data, which is to be transmitted (e.g., to a station) by the access point; receiving a media access control (MAC) service data unit (MSDU) (e.g., where the MSDU is or includes an IP packet with an IP packet header including an ECN field including an ECT bit and a CE bit) with associated ECN bits, said associated ECN bits including an associated Explicit Congestion Notification (ECN) Capable Transport (ECT) bit and an associated Congestion Experienced (CE) bit; and determining, (2036) based on whether the ECN bits associated with the MSDU are set to 11, whether to provide the MSDU priority transmission treatment corresponding to an ECN setting of 11 or a standard level of transmission treatment.

Method Embodiment 1A. The method of Method Embodiment 1, wherein one of said one or more qualifiers includes a parameter which has an associated ECT bit set to 1 and an associated CE bit set to 1.

Method Embodiment 1B. The method of Method Embodiment 1A, wherein said parameter is: ECN{11}.

Method Embodiment 1D. The method of Method Embodiment 1, wherein said classifier type field is set to the value 11 (see new classifier type 11 1806 (which was previously reserved) in frame classifier type table 1800).

Method Embodiment 1E. The method of Method Embodiment 1, wherein said classifier type field (1706 or 1908) and said classifier parameters field (1708 or 1910) are part of a frame classifier (1606 or 1700 or 1906) included as part of a traffic classification (TCLAS) element (TCLAS element 1600 included in TCLAS elements field 1506 or TCLAS element 1904).

Method Embodiment 1F. The method of Method Embodiment 1, wherein indicating how the AP is to treat data to be transmitted includes indicating Quality of Service (QOS) information.

Method Embodiment 1G. The method of Method Embodiment 1F, wherein said QoS information includes transmission frame rate information (e.g., frame per second (fps) rate information or fps rate adjustment information for video frames.)

Method Embodiment 2. The method of Method Embodiment 1, further comprising: enabling (e.g., activating 2006), prior to receiving the MSDU, a WiFi Low Latency, Low Loss, and Scalable Throughput (L4S) mode of operation (e.g., set the AP to a mode of operation in which it will interpret the combination of ECT bit set to 1 and CE bit set to 1 in an IP header ECN field corresponding to an IP packet as a request for L4S like treatment of the data in the corresponding IP packet).

Method Embodiment 2A. The method of Method Embodiment 2, further comprising: determining (20081) if the access point employs access classes for best effort and background traffic.

Method Embodiment 2B. The method of Method Embodiment 2, wherein said determining (20081) if the access point employs access classes for best effort and background traffic determines that (as indicated by Y 200811) the access point does employ access classes for best effort and background traffic; and in response to determining that (as indicated by Y 200811) the access point does employ access classes for best effort and background traffic, performing the steps of: enabling (e.g., setting) (20082) a WiFi Robust AV Streaming Implemented mode of operation in the access point; and enabling (e.g., setting) (20083) a WiFi QoS Option Implemented mode of operation in the access point.

Method Embodiment 3. The method of Method Embodiment 2, wherein in response to determining (2036) that the ECN bits associated with the MSDU are set to 11, the MSDU is transmitted (2038) at a priority level which supports a frames per second rate for satisfying L4S.

Method Embodiment 3A. The method of Method Embodiment 2, wherein in response to determining (2036) that the ECN bits associated with the MSDU are set to 11, the MSDU is transmitted (2038) at a priority level which satisfies some, but not necessarily all of the L4S requirements (e.g., satisfies a predetermined or set video frame rate).

Method Embodiment 4. The method of Method Embodiment 1, further comprising: storing (2022) the received MSDU in a buffer (e.g., a regular buffer); checking (2024) if a buffer congestion threshold in said buffer has been reached; andin response to determining that the buffer congestion threshold has been reached (e.g., the buffer has reached or exceeded the congestion threshold in terms of the amount of data in the buffer), setting (2030) a congestion experienced (CE) codepoint (ECN bits (ECT, CE)=11) associated with the MSDU to 1.

Method Embodiment 5. The method of Method Embodiment 4, wherein said AP performs ECN marking operations (2030/2032) corresponding to MSDUs passing through each of multiple video transmission buffers (e.g., a primary VI transmission queue (2312) and an alternate VI transmission queue (2314).)

Method Embodiment 6. The method of Method Embodiment 4, wherein said AP performs ECN marking operations (2030/2032) corresponding to MSDUs passing through each of voice and video transmission buffers (primary VO transmission queue (2308), alternate VO transmission queue (2310), primary VI transmission queue (2312) and alternate VI transmission queue (2314.)

### Fifth List of Numbered Exemplary Apparatus Embodiments

Apparatus Embodiment 1. An access point (AP) (302 or 1200), comprising: a wireless receiver (1218); a network interface receiver (1242); a storage device (e.g., memory 1210) (e.g., including transmission buffers (2308, 2310, 2312, 1314, 2316, 2318)) and a processor (1202) configured to operate the access point (302) to: receive (2014) (via wireless receiver (1218)) an Stream Classification Service (SCS) Request frame (1900) from a station (STA) (320), said SCS Request frame (1900) including an SCS descriptor element (1500 or 1902) including a classifier type field (1706 or 1908) set to an integer value in the range of 11-255, said value indicating that a corresponding classifier parameters field (1708 or 1910) included in SCS descriptor element (1500 or 1902) will include one or more qualifiers indicating how the AP (302) is to treat data, which is to be transmitted (e.g., to a station) by the access point (302); receive (e.g., via network interface receiver 1242) a media access control (MAC) service data unit (MSDU) (e.g., where the MSDU is or includes an IP packet with an IP packet header including an ECN field including an ECT bit and a CE bit) with associated Explicit Congestion Notification (ECN) bits, said associated ECN bits including an associated ECN Capable Transport (ECT) bit and an associated Congestion Experienced (CE) bit; and determine, (2036) based on whether the ECN bits associated with the MSDU are set to 11, whether to provide the MSDU priority transmission treatment corresponding to an ECN setting of 11 or a standard level of transmission treatment.

Apparatus Embodiment 1A. The access point (302) of Apparatus Embodiment 1, wherein one of said one or more qualifiers includes a parameter which has an associated ECT bit set to 1 and an associated CE bit set to 1.

Apparatus Embodiment 1B. The access point (302) of Apparatus Embodiment 1A, wherein said parameter is: ECN{11}.

Apparatus Embodiment 1D. The access point (302) of Apparatus Embodiment 1, wherein said classifier type field is set to the value 11 (see new classifier type 11 1806 (which was previously reserved) in frame classifier type table 1800).

Apparatus Embodiment 1E. The access point (302) of Apparatus Embodiment 1, wherein said classifier type field (1706 or 1908) and said classifier parameters field (1708 or 1910) are part of a frame classifier (1606 or 1700 or 1906) included as part of a traffic classification (TCLAS) element (TCLAS element 1600 included in TCLAS elements field 1506 or TCLAS element 1904).

Apparatus Embodiment 1F. The access point (302) of Apparatus Embodiment 1, wherein indicating how the AP is to treat data to be transmitted includes indicating Quality of Service (QOS) information.

Apparatus Embodiment 1G. The access point (302) of Apparatus Embodiment 1F, wherein said QoS information includes transmission frame rate information (e.g., frame per second (fps) rate information or fps rate adjustment information for video frames.)

Apparatus Embodiment 2. The access point (302) of Apparatus Embodiment 1, wherein said processor (1202) is further configured to operate the access point (302) to: enable (e.g., activate 2006), prior to receiving the MSDU, a WiFi Low Latency, Low Loss, and Scalable Throughput (L4S) mode of operation (e.g., set the AP to a mode of operation in which it will interpret the combination of ECT bit set to 1 and CE bit set to 1 in an IP header ECN field corresponding to an IP packet as a request for L4S like treatment of the data in the corresponding IP packet).

Apparatus Embodiment 2A. The access point (302) of Apparatus Embodiment 2, wherein said processor (1202) is further configured to operate the access point (302) to: determine (20081) if the access point employs access classes for best effort and background traffic.

Apparatus Embodiment 2B. The access point (302) of Apparatus Embodiment 2A, wherein said processor (1202) is configured to operate the access point determine that (as indicated by Y 200811) the access point does employ access classes for best effort and background traffic, as part of being configured to determine (20081) if the access point employs access classes for best effort and background traffic; and in response to determining that (as indicated by Y 200811) the access point does employ access classes for best effort and background traffic, operate the access point (302) to perform the steps of: enabling (e.g., setting) (20082) a WiFi Robust AV Streaming Implemented mode of operation in the access point; and enabling (e.g., setting) (20083) a WiFi QoS Option Implemented mode of operation in the access point.

Apparatus Embodiment 3. The access point (302) of Apparatus Embodiment 2, further comprising: a wireless transmitter (1220); and wherein said processor (1202) is further configured to operate the access point (302) to transmit (2038) (via wireless transmitter 1220) the MSDU at a priority level which supports a frames per second rate for satisfying L4S, in response to determining (2036) that the ECN bits associated with the MSDU are set to 11.

Apparatus Embodiment 3A. The access point (302) of Apparatus Embodiment 2, wherein said processor (1202) is configured to operate the access point (302) to transmit (2038) the MSDU at a priority level which satisfies some, but not necessarily all of the L4S requirements (e.g., satisfies a predetermined or set video frame rate), in response to determining (2036) that the ECN bits associated with the MSDU are set to 11.

Apparatus Embodiment 4. The access point (302) of Apparatus Embodiment 1, wherein said processor (1202) is further configured to operate the access point (302) to: store (2022) the received MSDU in a buffer included in said storage device (e.g., a regular buffer); check (2024) if a buffer congestion threshold in said buffer has been reached; and in response to determining that the buffer congestion threshold has been reached (e.g., the buffer has reached or exceeded the congestion threshold in terms of the amount of data in the buffer), set (2030) a congestion experienced (CE) codepoint (ECN bits (ECT, CE)=11) associated with the MSDU to 1.

Apparatus Embodiment 5. The access point (302) of Apparatus Embodiment 4, wherein said processor (1202) is configured to operate the AP (302) to perform ECN marking operations (2030/2032) corresponding to MSDUs passing through each of multiple video transmission buffers (e.g., a primary VI transmission queue (2312) and an alternate VI transmission queue (2314.)

Apparatus Embodiment 6. The access point (302) of Apparatus Embodiment 4, wherein processor (1202) is configured to operate said AP to perform ECN marking operations (2030/2032) corresponding to MSDUs passing through each of voice and video transmission buffers (primary VO transmission queue (2308), alternate VO transmission queue (2310), primary VI transmission queue (2312) and alternate VI transmission queue (2314).)

### Sixth List of Numbered Exemplary Method Embodiments

Method Embodiment 1. A method of operating a station (STA) (320) (e.g., a WiFi STA), the method comprising: enabling (e.g., activating 2006), a WiFi Low Latency, Low Loss, and Scalable Throughput (L4S) mode of operation (e.g., set the STA to a mode of operation in which it will interpret the combination of ECT bit set to 1 and CE bit set to 1 in an IP header ECN field corresponding to an IP packet as a request for L4S like treatment of the data in the corresponding IP packet).

Method Embodiment 2. The method of Method Embodiment 1, further comprising: determining (20071) if the STA employs access classes for best effort and background traffic.

Method Embodiment 3. The method of Method Embodiment 2, wherein said determining (20071) if the STA employs access classes for best effort and background traffic determines that (as indicated by Y 200711) the STA does employ access classes for best effort and background traffic; and in response to determining that (as indicated by Y 200711) the STA does employ access classes for best effort and background traffic, performing the steps of: enabling (e.g., setting) (20072) a WiFi Robust AV Streaming Implemented mode of operation in the access point; and enabling (e.g., setting) (20073) a WiFi QoS Option Implemented mode of operation in the access point.

Method Embodiment 4. The method of Method Embodiment 3, further comprising: operating the STA to receive (2039) a Media Access Control (MAC) Service Data Unit (MSDU) from an access point (302).

Method Embodiment 5. The method of Method Embodiment 4, wherein received MSDU includes an IP packet header including Explicit Congestion Notification Bits (ECN) bits set to 11.

Method Embodiment 6. The method of Method Embodiment 4, wherein said access point is also in a WiFi L4S mode of operation, a WiFi Robust AV Streaming Implemented mode of operation and a WiFi QoS Option Implemented mode of operation.

### Sixth List of Numbered Exemplary Apparatus Embodiments

Apparatus Embodiment 1. A station (STA) (320 or 1300) (e.g., a WiFi STA) comprising: a wireless receiver (1324); and a processor (1302) configured to operate the station (320) to: enable (e.g., activate 2006), a WiFi Low Latency, Low Loss, and Scalable Throughput (L4S) mode of operation (e.g., set the STA to a mode of operation in which it will interpret the combination of ECT bit set to 1 and CE bit set to 1 in an IP header ECN field corresponding to an IP packet as a request for L4S like treatment of the data in the corresponding IP packet).

Apparatus Embodiment 2. The STA (320) of Apparatus Embodiment 1, wherein said processor (1302) is further configured to operate the STA (320) to: determine (20071) if the STA employs access classes for best effort and background traffic.

Apparatus Embodiment 3. The STA (320) of Apparatus Embodiment 2, wherein said processor (1302) is configured to operate the STA to: determine that (as indicated by Y 200711) the STA does employ access classes for best effort and background traffic, as part of being configured to operate the STA to determine (20071) if the STA employs access classes for best effort and background traffic; and in response to determining that (as indicated by Y 200711) the STA does employ access classes for best effort and background traffic, perform the steps of: enabling (e.g., setting) (20072) a WiFi Robust AV Streaming Implemented mode of operation in the access point; and enabling (e.g., setting) (20073) a WiFi QoS Option Implemented mode of operation in the access point.

Apparatus Embodiment 4. The STA (320) of Apparatus Embodiment 3, wherein said processor (1302) is further configured to: operating the STA (320) to receive (2039) (e.g., via wireless receiver (1324)) a Media Access Control (MAC) Service Data Unit (MSDU) from an access point (302).

Apparatus Embodiment 5. The STA (320) of Apparatus Embodiment 4, wherein received MSDU includes an IP packet header including Explicit Congestion Notification (ECN) bits set to 11.

Apparatus Embodiment 6. The STA (320) of Apparatus Embodiment 4, wherein said access point is also in a WiFi L4S mode of operation, a WiFi Robust AV Streaming Implemented mode of operation and a WiFi QoS Option Implemented mode of operation.

### Non-Transitory Machine Readable Embodiments

Various embodiments are directed to a non-transitory machine readable storage device, e.g., memory, with processor executable instructions stored thereon, which when executed by a processor of an apparatus, e.g., access point or station, control the apparatus to implement any one or more of the above described methods or numbered method embodiments.

The techniques of various embodiments may be implemented using software, hardware and/or a combination of software and hardware. Various embodiments are directed to apparatus, e.g., access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In some embodiments a buffer is implemented in the form of a queue. Thus, the terms buffers and queues are sometimes used to refer to the same thing.

In various embodiments devices, e.g., access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning APs, STAs, user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., access point (AP), e.g., WiFi AP, supporting SCS and/or MSCS, station (STA), e.g., WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., access points (AP), e.g., WiFi AP, supporting SCS and/or MSCS, stations (STA), e.g., WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., an access point (AP), e.g., WiFi AP, supporting SCS and/or MSCS, a stations (STA), e.g., a WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such an access points (AP), e.g., a WiFi AP, supporting SCS and/or MSCS, a station (STA), e.g., WiFi STA, supporting SCS and/or MSCS, a user equipment device, wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating an access point (AP), comprising:
receiving a Stream Classification Service (SCS) Request frame from a station, said SCS Request frame including an SCS descriptor element including a classifier type field set to an integer value in the range of 11-255, said value indicating that a corresponding classifier parameters field included in SCS descriptor element will include one or more qualifiers indicating how the AP is to treat data, which is to be transmitted by the access point;
receiving a media access control (MAC) service data unit (MSDU) with associated ECN bits, said associated ECN bits including an associated Explicit Congestion Notification (ECN) Capable Transport (ECT) bit and an associated Congestion Experienced (CE) bit; and
determining, based on whether the ECN bits associated with the MSDU are set to 11, whether to provide the MSDU priority transmission treatment corresponding to an ECN setting of 11 or a standard level of transmission treatment.

2. The method of claim 1, wherein one of said one or more qualifiers includes a parameter which has an associated ECT bit set to 1 and an associated CE bit set to 1.

3. The method of claim 1, wherein said classifier type field is set to the value 11.

4. The method of claim 1, wherein said classifier type field and said classifier parameters field are part of a frame classifier included as part of a traffic classification (TCLAS) element.

5. The method of claim 1, wherein indicating how the AP is to treat data to be transmitted includes indicating Quality of Service (QOS) information.

6. The method of claim 5, wherein said QoS information includes transmission frame rate information.

7. The method of claim 1, further comprising:
enabling, prior to receiving the MSDU, a WiFi Low Latency, Low Loss, and Scalable Throughput (L4S) mode of operation.

8. The method of claim 7, wherein in response to determining that the ECN bits associated with the MSDU are set to 11, the MSDU is transmitted at a priority level which supports a frames per second rate for satisfying L4S.

9. The method of claim 1, further comprising:
storing the received MSDU in a buffer;
checking if a buffer congestion threshold in said buffer has been reached; and
in response to determining that the buffer congestion threshold has been reached, setting a congestion experienced (CE) codepoint (ECN bits (ECT, CE)=11) associated with the MSDU to 1.

10. The method of claim 9, wherein said AP performs ECN marking operations corresponding to MSDUs passing through each of multiple video transmission buffers.

11. The method of claim 9, wherein said AP performs ECN marking operations corresponding to MSDUs passing through each of voice and video transmission buffers.

12. An access point (AP), comprising:
a wireless receiver;
a network interface receiver;
a storage device; and
a processor configured to operate the access point to:
receive an Stream Classification Service (SCS) Request frame from a station (STA), said SCS Request frame including an SCS descriptor element including a classifier type field set to an integer value in the range of 11-255, said value indicating that a corresponding classifier parameters field included in SCS descriptor element will include one or more qualifiers indicating how the AP is to treat data, which is to be transmitted by the access point;
receive a media access control (MAC) service data unit (MSDU) with associated Explicit Congestion Notification (ECN) bits, said associated ECN bits including an associated ECN Capable Transport (ECT) bit and an associated Congestion Experienced (CE) bit; and
determine, based on whether the ECN bits associated with the MSDU are set to 11, whether to provide the MSDU priority transmission treatment corresponding to an ECN setting of 11 or a standard level of transmission treatment.

13. The access point of claim 12, wherein one of said one or more qualifiers includes a parameter which has an associated ECT bit set to 1 and an associated CE bit set to 1.

14. The access point of claim 12, wherein said classifier type field is set to the value 11.

15. The access point of claim 1, wherein said classifier type field and said classifier parameters field are part of a frame classifier included as part of a traffic classification (TCLAS) element.

16. The access point of claim 12, wherein said processor is further configured to operate the access point to:
enable, prior to receiving the MSDU, a WiFi Low Latency, Low Loss, and Scalable Throughput (L4S) mode of operation.

17. The access point of claim 16, further comprising:
a wireless transmitter; and
wherein said processor is further configured to operate the access point to transmit the MSDU at a priority level which supports a frames per second rate for satisfying L4S, in response to determining that the ECN bits associated with the MSDU are set to 11.

18. The access point of claim 16, wherein said processor is further configured to operate the access point to:
store the received MSDU in a buffer included in said storage device;
check if a buffer congestion threshold in said buffer has been reached; and
in response to determining that the buffer congestion threshold has been reached, set a congestion experienced (CE) codepoint (ECN bits (ECT, CE)=11) associated with the MSDU to 1.

19. A method of operating a station (STA), the method comprising:
enabling, a WiFi Low Latency, Low Loss, and Scalable Throughput (L4S) mode of operation

20. The method of claim 19, further comprising:
determining if the STA employs access classes for best effort and background traffic.

21. The method of claim 20, wherein said determining if the STA employs access classes for best effort and background traffic determines that the STA does employ access classes for best effort and background traffic; and
in response to determining that the STA does employ access classes for best effort and background traffic, performing the steps of:
enabling a WiFi Robust AV Streaming Implemented mode of operation in the access point; and
enabling a WiFi QoS Option Implemented mode of operation in the access point.

22. The method of claim 21, further comprising:
operating the STA to receive a Media Access Control (MAC) Service Data Unit (MSDU) from an access point.

23. The method of claim 22, wherein received MSDU includes an IP packet header including Explicit Congestion Notification (ECN) bits set to 11.

24. The method of claim 22, wherein said access point is also in a WiFi L4S mode of operation, a WiFi Robust AV Streaming Implemented mode of operation and a WiFi QoS Option Implemented mode of operation.

25. A station (STA) comprising:
a wireless receiver; and
a processor configured to operate the station to:
enable, a WiFi Low Latency, Low Loss, and Scalable Throughput (L4S) mode of operation.

26. The STA of claim 25, wherein said processor is further configured to operate the STA (320) to:
determine if the STA employs access classes for best effort and background traffic.

27. The STA of claim 26, wherein said processor is configured to operate the STA to:
determine that the STA does employ access classes for best effort and background traffic, as part of being configured to operate the STA to determine if the STA employs access classes for best effort and background traffic; and
in response to determining that the STA does employ access classes for best effort and background traffic, perform the steps of:
enabling a WiFi Robust AV Streaming Implemented mode of operation in the access point; and
enabling a WiFi QoS Option Implemented mode of operation in the access point.

28. The STA of claim 27, wherein said processor is further configured to:
operating the STA to receive a Media Access Control (MAC) Service Data Unit (MSDU) from an access point.

29. The STA of claim 28, wherein received MSDU includes an IP packet header including Explicit Congestion Notification (ECN) bits set to 11.

30. The STA of claim 28, wherein said access point is also in a WiFi L4S mode of operation, a WiFi Robust AV Streaming Implemented mode of operation and a WiFi QoS Option Implemented mode of operation.
